(19) United States
(12) Patent Application Publication
(10) Pub. No.: US 2011/0161348 A1
(43) Pub. Date: Jun. 30, 2011

(54) System and Method for Automatically Creating a Media Compilation

(76) Inventor: Avi Oron, Cresskill, NJ (US)

(21) Appl. No.: 12/673,347

(22) PCT Filed: Aug. 15, 2008
(86) PCT No.: PCT/US08/73336

§ 371 Date: Feb. 12, 2010

Related U.S. Application Data
(60) Provisional application No. 60/956,630, filed on Aug. 17, 2007.

(51) Int. Cl. G06F 17/30

(52) U.S. Cl. 707/769; 707/E17.014

(57) ABSTRACT

A media creation system enabling the automatic compilation file by combining a plurality of different media source files. A media processor automatically initiates a search of media files stored in the repository based on the received criteria data and the metadata associated with the file to produce a list of a plurality of different types of media files wherein each respective media files satisfies the criteria. Media processor automatically and randomly selects a first media file in a first data format from the list and at least one other media file in a second data format. A compiler produces a media compilation file for display including the first and the at least one second media file, the at least one second media file being displayed concurrently with the first media file.

### FIELD OF THE INVENTION

The present invention relates generally to the field of media creation, and more specifically to a system for automatically creating a processed media file from a plurality of different media files for view and distribution across a communication network.

### BACKGROUND OF THE INVENTION

Computer systems and applications exist that allow users to create audio, video and graphic media files. Users may then separately manipulate and edit each respective media file to user specification. However, editing and manipulating different media files requires a user to have advanced knowledge of multiple computer applications, for example, Adobe Photoshop for graphic images and Adobe Premiere for video data. The user must also be knowledgeable in editing styles and techniques in order to manipulate different file types into a cohesive single media file that is visually pleasing for a viewing audience. Presently, all creative editing must be performed manually by the direction of a user using specific computing applications. While automatic editing applications do exist, the resulting media created by existing automatic editing applications is very basic and results in a product that does not look professionally produced. A need exists for a system that dynamically and automatically uses creative artificial intelligence to produce a processed media file or clip from a plurality of different media file types that is visually pleasing for display and distribution to a plurality of users. A system according to invention principles addresses these deficiencies and associated problems

### BRIEF SUMMARY OF THE INVENTION

An aspect of the present invention is a media creation system for automatically and randomly creating a media compilation file from a plurality of different media source files. A repository includes a plurality of different types of media files stored therein, the media files each having metadata associated therewith. An input processor receives user specified criteria data. A media processor automatically initiates a search of media files stored in the repository based on the received criteria data to produce a list of a plurality of different types of media files wherein each respective media file satisfies the criteria. Media processor automatically and randomly selects a first media file in a first data format from the list and at least one second media file in a second data format. The at least one second media file being associated with the said first media file. A compiler produces a media compilation file for display including the first and the at least one second media file, the at least one second media file being displayed concurrently with the first media file.

### BRIEF DESCRIPTION OF THE DRAWING

FIG. 1 is a block diagram of the system for automatically creating a media compilation according to invention principles;

FIG. 2 is a flow diagram detailing the operation of the automatic media compilation system shown in FIG. 1 according to invention principles;

FIG. 3 is a schematic diagram detailing how the media compilation file is produced according to invention principles;

FIG. 4 is XML code representing an exemplary media compilation file created according to invention principles;

FIG. 5 is an exemplary display image of a user interface for creating a media compilation according to invention principles;

FIG. 6 is an exemplary display image of a user interface player displaying a particular video clip of a media compilation produced according to invention principles;

FIG. 7 is an exemplary display image of a user interface player displaying a particular video clip and graphic image of a media compilation produced according to invention principles;

FIGS. 8A-8J are exemplary display images of a user interface media creator and player for producing and playing a media compilation according to invention principles;

FIG. 9 is a block diagram illustrating a display image in a user interface for editing a media compilation according to invention principles;

FIG. 9A is an exemplary display image of the user interface of FIG. 9 according to invention principles;

FIGS. 10A-10C are exemplary display images of different user interfaces for editing a media compilation according to invention principles;

FIG. 11 is a block diagram of the slide show media compilation conversion system according to invention principles;

FIG. 12 is a schematic diagram of a slide being converted by the system of FIG. 11 according to invention principles;

FIG. 13 is a schematic diagram of a slide being converted by the system of FIG. 11 according to invention principles;

FIG. 14 is a schematic diagram of a slide being converted by the system of FIG. 11 according to invention principles;

FIG. 15 is a flow diagram detailing the operation of the slide show media compilation conversion system according to invention principles;

FIG. 16 is a block diagram of a word processing compatible document conversion and media production system according to invention principles;

FIG. 17 is an exemplary source document for use with the system of FIG. 16 according to invention principles;

FIG. 18 is an exemplary source document for use with the system of FIG. 16 according to invention principles;

FIG. 19 is a block diagram of a video story media compilation creation system according to invention principles;

FIGS. 19A-19C are exemplary display images of user interfaces of the video story media compilation creation system shown in FIG. 19 according to invention principles;

FIG. 20 is an illustrative view of family tree representative data for use by a family tree media compilation creation system according to invention principles;

FIG. 21 is a block diagram of a family tree media compilation creation system according to invention principles;

FIG. 22 is a flow diagram detailing the operation of the family tree media compilation creation system according to invention principles;

FIG. 23 is a block diagram of a user-entered media clip editing system for use in a media compilation system according to invention principles;

FIG. 24 is a flow diagram detailing the operation of the system of FIG. 23 according to invention principles;

FIG. 25 is a flow diagram that continues the operation described in FIG. 24 according to invention principles; and

FIG. 26 is a block diagram of a system for converting text message data into an media compilation according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor is hardware. Alternatively, a processor may comprise any combination of, hardware, firmware, and/or software. Processors may be electrically coupled to one another enabling communication and signal transfers therebetween.

An executable application, as used herein, comprises code or machine readable instructions for conditioning the processor to implement predetermined functions, such as those of an operating system, software development planning and management system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

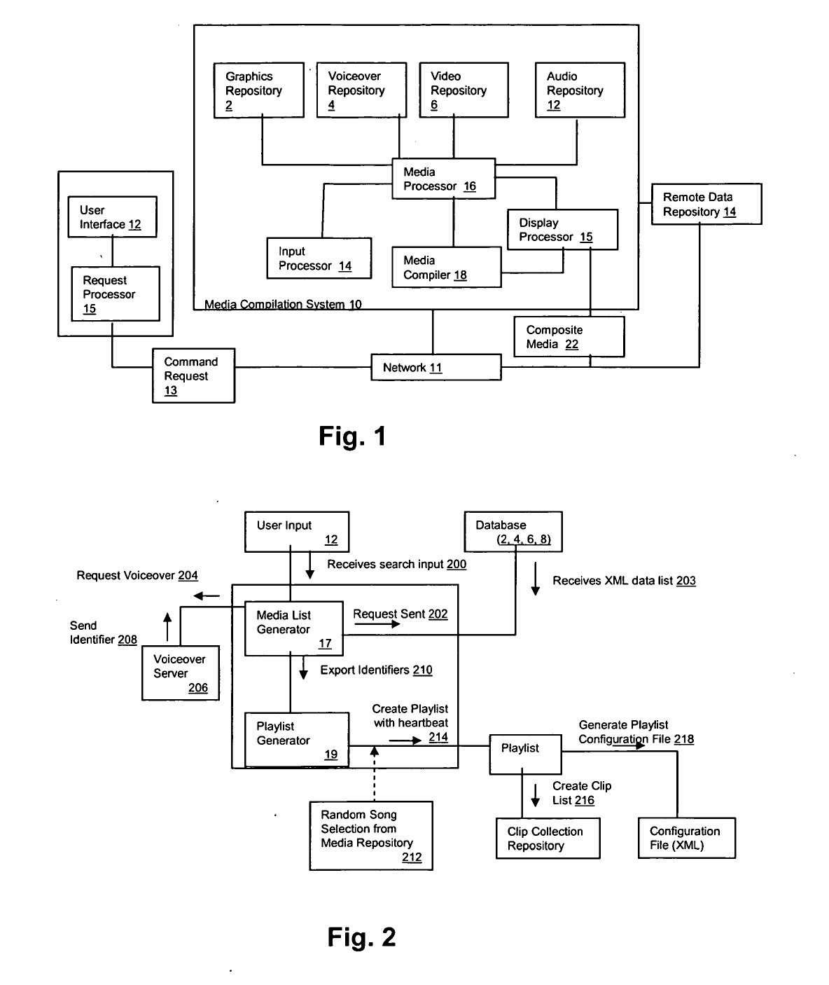

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. The steps and functions performed by the systems and processes of FIGS. 1-26 may be performed wholly or partially automatically or in response to user command.

Different file formats associated with particular files are described herein. For example, a file formatted as an extensible markup language (XML) file, may be used for a particular data object being communicated to one or more components of the system for a particular purpose. However, the description of the particular data object format is provided for purpose of example only and any other configuration file format that is able to accomplish the objective of the system may be used.

A block diagram of the media compilation system 10 is shown in FIG. 1. The system 10 may be connected via a communications network 11 to and communicate with any of a plurality of users 12 and a plurality of remote storage repositories 14.

Communication between the system 10 and any device connected thereto may occur in any of a plurality data formats including, without limitation, an an Ethernet protocol, an Internet Protocol (I.P.) data format, a local area network (LAN) protocol, a wide area network (WAN) protocol, an IEEE bus compatible protocol, HTTP and HTTPS. Network communication paths may be formed as a wired or wireless (W/WL) connection. The wireless connection permits a user 12 communicating with system 10 to be mobile beyond the distance permitted with a wired connection. The communication network 11 may comprise the Internet or an Intranet connecting a departments or entities within a particular organization. Additionally, while elements described herein are separate, it is well known that they may be present in a single device or in multiple devices in any combination. For example, as shown in FIG. 1, system 10 includes repositories 2, 4, 6 and 8 that are local and remote data repository 14 located remotely from system 10. The components of system 10 may each be connected directly to one another without the use of a communications network or may be connected to one another via communications network 11.

The media compilation system 10 advantageously enables a user to select various criteria data and automatically create a composite media file from a plurality of different types of media clips. Media clips as used herein refer to audio data files, video data files, graphical image data files and voiceover data files. Voiceover data files may be produced by a text-to-voice conversion program in a manner that is known. Media clips may be formatted in any file format and many different file format types may be used to produce the composite media clip. For example, video clips may be formatted as, but not limited to, Windows Media Video (WMV), Flash (FLV or SWF), Audio Video Interleave (AVI), Quicktime (MOV) and/or MPEG 1, 2 or 4. Audio clips may be formatted in a compressed or uncompressed file format and may include, but are not limited to, Windows Media Audio (WMA), MPEG Layer 2 or 3 (MP2 or MP3), Apple Lossless (M4A) and/or Windows Wave (WAV). Graphic image clips may be formatted as JPEG (JPG), Windows Bitmap files (BMP), Tagged Image File Format (TIFF), Adobe Photoshop (PSD, PDD) and/or Graphics Interchange Format (GIF). The voiceover data files may be output by the text-to-voice conversion program in any audio file format. It is important to note that the above list of audio, video and graphic file formats is not exclusive and system 10 may store, utilize and compile media clips in any file format that is available.

System 10 enables a user to automatically produce a composite media file that is compiled in such a manner that it appears to have been produced and edited by person skilled in the art and techniques of audio-visual editing. An exemplary use of system 10 is to enable a small business user to automatically produce a composite media file for use as at least one of an advertisement on television and/or on a webpage, sales video, promotional video and multimedia slideshow presentations. The user is able to select from a plurality of different media types and categories and have media clips that correspond to the user's specification automatically be compiled. The user may also input user specific information, i.e. text, which is converted into a voiceover media file that may be combined with the audio and video clips selected by system 10 for compilation thereof. Upon user specification of media criteria and input of any user specific information, and in response to a single user command and/or request, system 10 automatically searches for and retrieves an audio clip and a plurality of video clips to be used in producing the composite media file. At least a portion or segment of each of the video clips will be automatically assigned and associated with a specific segment of the music clip file such that associated video segments are displayed simultaneous with the music segments. Additionally, voiceover media is added and associated with specific audio and/or video segments and displayed simultaneously therewith. Should the user criteria return at least one graphic media file, the graphic may also be associated with any of the audio and video clips and displayed simultaneously therewith. Composite media file may, throughout the duration of display, include any combination of audio, video, graphic image and voiceover data to successfully and attractively convey information to a viewer and appears as if it was produced by an editing professional.

The media clips utilized by system 10 may be prefabricated or user provided media clips. The media clips may be stored in the plurality of media repositories (2; 4, 6, 8) shown in FIG. 1. While four media repositories are shown each specific to a type of media clip utilized by system 10, they are shown for purposes of example only and media clips may be stored in a single repository or any number of different repositories either may be used to store the media thereon. Each of the prefabricated audio (music) clips, video clips and graphic image clips may tagged with metadata that includes information about the specific media clip. The tagging may be performed by professional editors, assistant editors, musicians, musical editors, graphic designers or any other person having the requisite creative skill to determine how to best use the respective media clip in a media compilation. The metadata tags associated with each respective media clip may provide data representing how, when and where the specific media clips should be used, for example, the type and style of music for a music clip or the scene shown in a video clip or a description of the image for a graphic clip. Additionally, the tag may provide information about which specific segments of the clip may be used at a specific time in the resulting media compilation. For example, a metadata tag for a video clip may include information corresponding to a segment of the video that may be used in a media compilation about pizza. System 10, when requested to produce a media compilation, may search for and retrieve location data representing the specific segment identified in the metadata tag and use the located segment as part of the resulting media compilation. The information contained within the metadata tag enables searching through a vast number of media clips of different type and format to retrieve clips that correspond to at least one a user entered search term and a user specified and selected search term from, for example, a drop down list of available terms. Moreover, the information data in each metadata tag may be used by a database system to create a linked database of media files that enables rapid search through a data repository which yields highly accurate results. The metadata tags associated with each media clip enables system 10 to respond to user specified requests to choose what type of media compilation is to be created.

The metadata tags associated with video clips may include information that will determine the use of that clip. For example, video use information may include data representative of any of categories in which that video clip can be used in; segments that are usable in the video clip; segments that are not usable in the video clip; description of people in the video clip (i.e. women, men, children, families, etc) descriptions of scenes and/or objects displayed in the video clip (i.e. water, beach, etc.); a camera action shown in the video clip (i.e. zoom in, zoom out, pan, tilt, focus, etc.); a description of the visual shot in the video clip (i.e, long shot, medium shot, close up, extreme close up, etc.); the ability to use the video clip as as a first shot and the ability to use the video clip as an end shot. The metadata video tags may provide information about the video clip as a whole or may also include sub tags including information about specific segments contained within the video clip thereby enabling the system to retrieve and use only the segments that satisfy the user specified criteria. The type of data described above that may be included in the video metadata tag for video files is provided for purposes of example only and any data describing any element of the video clip may be used.
The metadata tags associated with graphic images may include information that will determine the use of that clip. Each graphic image stored in a repository will be categorized and tagged with graphic image metadata tag. Graphic image metadata tags may include data representative of any of image category; image description; logo data; superimposing data (i.e. data identifying if the graphic may be superimposed over any of music or video); image effects data (i.e, rain, snow, stars, waves, etc); animation data indicating any animated elements within the image and transition data indicating use as a transitional image including dissolves, wipes or any other transitional effect. The type of data described above that may be included in the graphic image metadata tag for graphic image files is provided for purposes of example only and any data describing any element of the graphic image clip may be used.
The metadata tags associated with music or audio clips may include information that will determine the use of that clip. Each music clip stored in a repository will be categorized and tagged with a metadata music tag. Music metadata tags may include music use information. Music use information of metadata music tags may include data representative of any of music genre; music style (i.e. classic, rock, fast, slow, etc.); music segment data; music segment style; music segment use data (i.e, length, edit style, etc.) and music category data (i.e., for commercial use, use during a PowerPoint presentation, essay, stories, etc.). The type of data described above that may be included in the music metadata tag for music files is provided for purposes of example only and any data describing any element of the music clip may be used.

Music metadata further includes data representing the musical heartbeat of the respective music file. Each music file usable by system 10 will be reviewed and edited and tagged by a musical editor to provide music heartbeat data by identifying a plurality of segments throughout the duration of the music file. The heartbeat includes segment markers that subdivide the music file into a plurality of segments that include data representing additional types of media (i.e. video, graphic, voiceover clips) that may be combined and overlaid on the specific segment of music when producing the media compilation. System 10 compares music segment data descriptors with video segment data descriptors, and if any of the descriptors match, system 10 may utilize the video segment for that particular music segment. The music heartbeat data is use by system 10 as the basis of the creative artificial intelligence of the media compilation system. Specifically, music heartbeat data enables the system to determine when cuts, dissolves and other editing techniques are to be applied. Additionally, the description data in the metadata tag of the video and graphic images are compared to the music heartbeat metadata tag to determine which specific media clips are useable with the particular selected music clip. Alternatively, the heartbeat data associated with the music metadata tag may be defined by any of an independent absolute timeline, beats per minute of the music selection of the music file, modified beats per minute data, or an application/processor that analyzes and automatically creates heartbeat data.

System 10 enables creation of voiceover data that audibilizes text that is entered by the user. System 10 automatically converts user entered text into voiceover data and simultaneously associates a voiceover metadata tag with the created voiceover data file. The conversion of text-to-voice data is a known process and performed by an executable application or processor within system 10. The voiceover metadata tag may include data representative of any of a user ID identifying which user initiated creation of the voiceover data; style of voice (i.e. male, female, adult, child); voice characteristic data (i.e. tonality, cadence, etc); number of different voice segments that comprise voiceover data clips; spacing data (i.e. user selectable objects that define predetermined amount of time between segments); order data specifying the order that the segments should be used and repetition data identifying if any segments should be repeated and including the timing of any repeated segments. Additionally, voiceover metadata may be created by a voiceover input template presented to a user that provides predetermined fields that define the spacing and timing that will be used in the media compilation. For example, a template may include three voice input fields each with a character limit that corresponds to an amount of time within the media compilation file.

User interface 12 enables a user to selectively communicate with media compilation system 10 via communication network 11. User interface 12 enables a user to selectively choose which feature of media compilation system 10 is to be used during a specific interaction. User interface 12 allows a user to select and specify criteria that system 10 will process and use when producing the media compilation. Additionally, user may enter text data into user interface 12 to be converted by system 10 into voiceover data that may be used as part of the media compilation. User entered data may also be converted into a graphic image, for example to display information identifying a business or a product. Once criteria data is entered, a user may initiate and communicate a single command request 13 by, for example, activating an image element in the user interface 12. Upon activating a command request 13, operation of a request processor 15 is initiated. Request processor 15 parses the data input by the user to create criteria data and voiceover data and provides parameters which govern the resulting media compilation produced by system 10 for association with the specific command request. In response to a single command request 13 provided to system 10 via communications network 11, system 10 automatically creates a media compilation 22 that matches the criteria data specified by the user and that contains voiceover data corresponding to the entered text. System 10 communicates data representing the media compilation 22 via communications network 11 for display in a media player of user interface 12. User interface 12 will be discussed in greater detail hereinafter with respect to FIGS. 5-10.

System 10 includes an input processor 14 for receiving user input via communications network 11 that is entered by a user through user interface 12 and a media processor 16 for processing and retrieving the plurality of media clips for the media compilation being produced. Media processor 16 is further connected to each of a graphics repository 2, voiceover repository 4, video repository 6 and audio repository 8. Graphics repository 2 provides a storage medium for graphic images each having graphic image metadata tags associated therewith. Voiceover repository 4 provides a storage medium for storing voiceover data that has been created by system 10 which includes voiceover metadata tag associated therewith. Video repository 6 provides a storage medium for storing a plurality of video clips each having video metadata tags associated therewith. Audio repository 8 provides a storage medium for storing a plurality of music (audio) clips each having music metadata tags associated therewith. Additionally, system 10 may be connected via communications network 11 to a remote media repository 14 that includes other media that may be used by system 10 to create the media compilation. Additionally, a further repository may be provided that enables a user to store user-uploaded or user-provided media clips for use in producing the media. User provided media may also include user metadata tags which are populated by a user either prior to providing the media or after providing the media clip when it is stored in the repository. The metadata tags populated by the user may be done using an executable application tagging tool that enables a user to select from a predetermined list of tags and/or enter user entered tags specific to the media. Input processor 14 selectively receives and sorts user criteria data to identify a type and style of media compilation to be automatically produced. Input processor 14 further receives the voiceover data and instructs the media processor 16 to convert text data into voice data to produce a voiceover file that is stored in voiceover repository 4. The sorted criteria data is provided to media processor 16 for use in retrieving media clips to produce the media compilation. Media processor 16 initiates a search of audio repository 8 for a plurality of audio clips that correspond to the criteria data specified by the user and randomly selects one of the plurality of music clips for use production of the media compilation. Media processor 16 further initiates a search of the graphic repository 2 and video repository 6 in order compile a list of other media clips useable for producing the media compilation 22. Media processor 16 randomly selects a plurality of video clips or segments of video clips that correspond to user criteria data and associates the clips or segments of clips with individual segments of the selected music clip. Media processor 16 retrieves voiceover data for the particular user that is stored in the voiceover repository and associates portions of the voiceover data with segments of music clip. Voiceover data may be associated with a segment having music data and at least one of video image data and graphic image data.

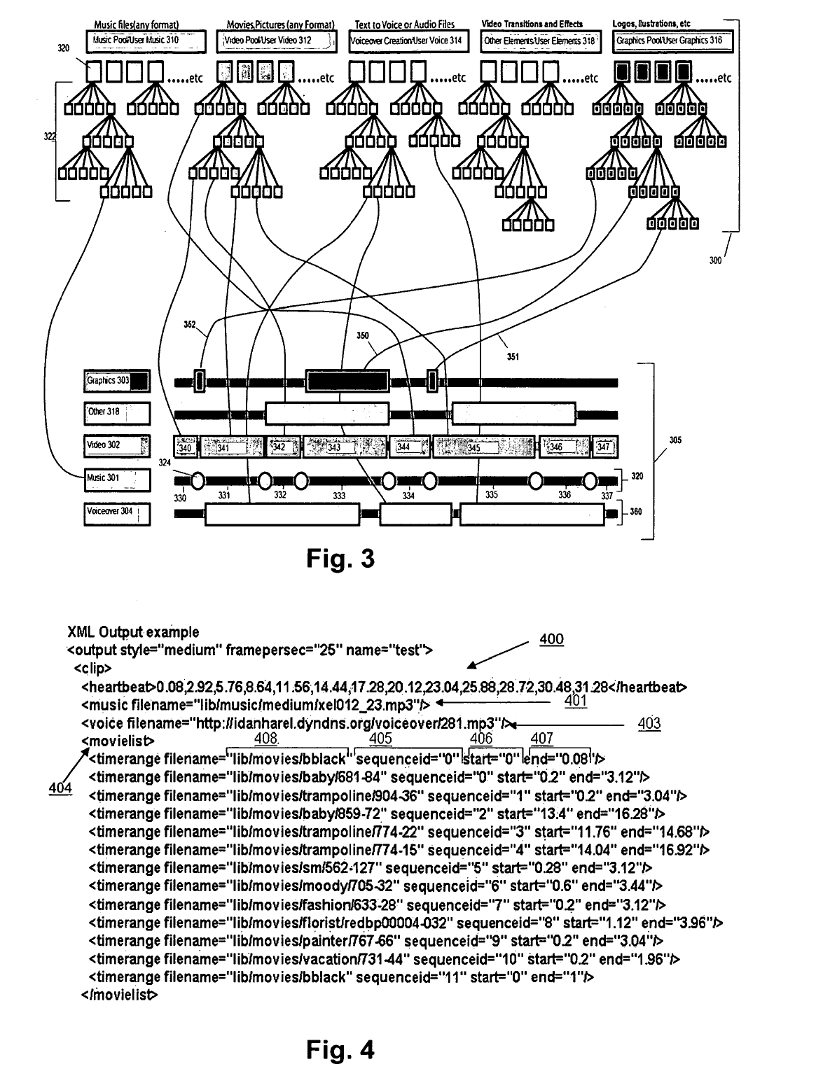

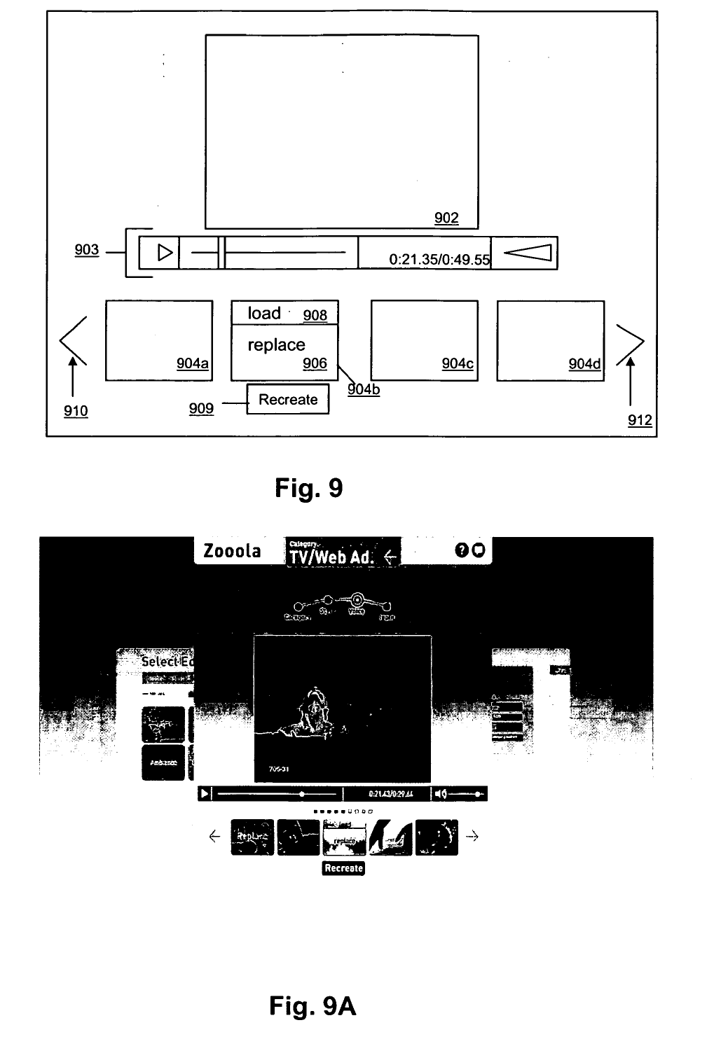

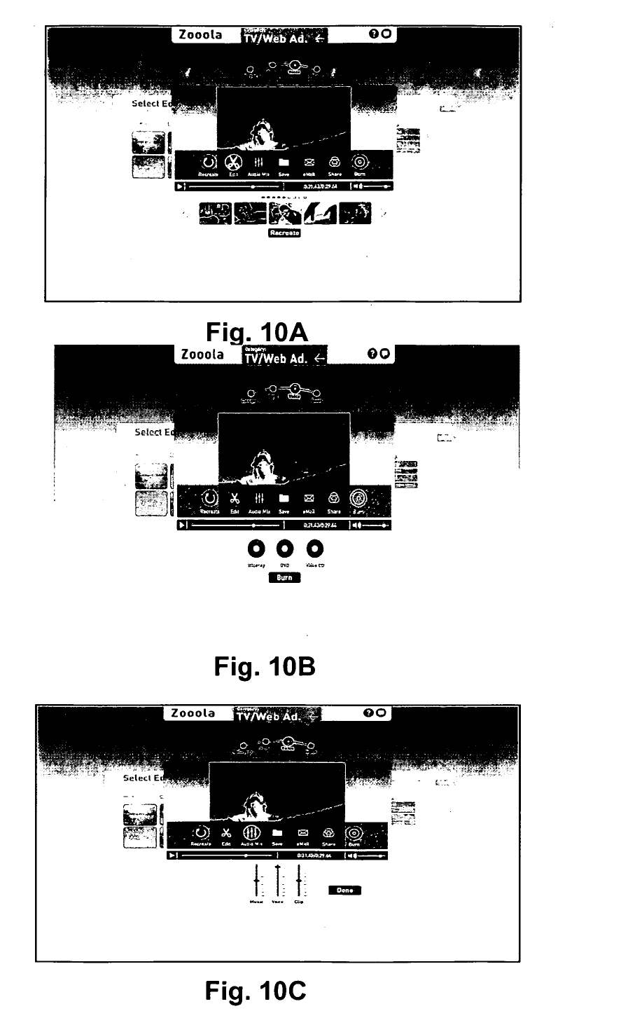

Media processor 16 provides associated media clips to media compiler 18 which compiles the associated media clips into a single composite media compilation. The compiler 18 may compile each clip selected by media processor 16 in the order specified by media processor 16 to produce data representing the media compilation file. Media compiler 18 is connected to display generator 20 which may creates display images associated with the compiled media file and provides the created display images as media compilation 22 to the user via communications network 11. Media compilation file 22 may include at least one of a Flash video file, media playlist file, media location identifier file in, for example, extensible markup language (XML) or an a single audio-visual file formatted as, for example, a MOV or AVI file. A media location identifier file provides instructions via communications network 11 to the user interface 12 including location information for each media clip used to create the media compilation 22. Use of a media location identifier file reduces the computing resources of the user and the bandwidth usage that is typically associated with transmission of large data files over communications networks. Media location identifier file will point to locations in the repositories of clips that are saved at a lower quality (i.e. reduced frame rate) to further reduce the stress on network communications. Should a user desire to obtain an actual digital copy of the file, the media compilation will be produced by using high quality media files to ensure the best and most professional looking output.
Upon viewing media compilation file 22 in a media player in the user interface 12, user may selectively determine if the media compilation file is satisfactory and initiate a download request from user interface which results in an actual media file, such as an AVI or MOV file being produced by compiler 18 and communicated via communications network 18. Alternatively, user may re-initiate a second command request using a single action which would re-send user criteria data and voiceover data to system 10 to produce a second different media compilation file. System 10 is able to produce an entirely different media compilation file because each respective clip that is part of the media compilation file is automatically randomly selected at each step by media processor 16. Thus, as the databases of tagged media clips expands, the chance of having the subsequent compiled media file be the same as previous media compilations files is diminished. Thus, user may selectively save and/or output a plurality of media compilations files that are based on the same user input but each being comprised of different media clips than previous or subsequent media compilation files.
Input processor 14 may selectively receive user-provided media clips in any data format for use in producing a media compilation file as discussed above. User provided media clips may be tagged with descriptors as metadata tags, similar to the pre-provided audio, video and graphic clips discussed above. Alternatively, input processor 14 may selectively receive data representing descriptors that is entered by a user at the user interface 12 and automatically associate the received metadata tag with the particular user-provided file. User provided media may be provided to system 10 in any manner including but not limited to uploading via a communications network 11, dialing in and recording voice data, providing a storage media (i.e, a compact disc or DVD) to a representative of system 10 or delivered to system 10 via common carrier. Media processor 16 may provide data representing an executable application to display generator 20 to generate and provide a further user editing display image element to the user at the user interface 12. User editing display image may be displayed after a first media compilation file has been produced and includes sub-image elements that enable a user to selective change and/or replace individual media clips of the media compilation file with at least one of other media clips listed on the list of matching media clips returned after the search of media repositories and user-provided media clips. The replacement of individual media clips occurs when a user selects an image element that signals the media processor 16 to search for and retrieve a further media clip. Additionally, a user may replace a single media clip with a specific user-selected media clip by, for example, uploading a user created media clip that is stored on a storage medium. The editing display image element and its features will further be discussed hereinafter with respect to FIGS. 9 and 10.
Additionally, the media processor 16 automatically initiates a search of all media clips in the repositories to determine if any newly added medic clips have descriptors in their respective metadata that were not previously there. Media processor 16 compiles an update list of new descriptors which is made available to the plurality of user systems. Request processors 15 may selectively ping media compilation system 10 for any available updates, and download updates as needed. Upon downloading new updates, request processor may modify the user interface to reflect the addition of new descriptors further enhancing the user experience with system 10.
FIG. 2 is a flow diagram detailing the operation of system 10 shown in FIG. 1. User inputs criteria data and voiceover data using user input 12 to select a type and style of a media compilation to be produced. At step S200, user may select different data categories to which each media clip used in producing the media compilation will correspond. The selection by the user may be performed in any manner including but not limited to, selection from a drop-down list, user input of criteria terms and user marking of selections listed in a dialog box. The voiceover data is entered as discussed above with respect to FIG. 1. In response to a single action by the user, the command request is generated and transmitted via communications network to media processor 16 of system 10. Shown herein, media processor 16 includes a media list generator 17 and playlist generator 19. Upon receipt of the command request generated in step S200, the file list generator 17 automatically initiates a search request in step S202 in databases 2, 6, 8 ands 14 of media files that satisfy the criteria data specified by the user. The search request, for each media clip, parses the data in each of the audio metadata tag, video metadata tag and graphic image metadata tag, to determine if the specified search criteria are present for each specific file. The file list generator parses and compares description data in the metadata tag with the specified criteria data in the request to matches terms that satisfy all specified criteria. This manner of searching is provided for exemplary purposes only and the media clips in the databases may be organized in a known manner such as in groupings or subdivisions that reduces the need to parse every media file after each request. A list of all media clips (audio, video and graphics) may be produced and encoded as an XML file, for example, and provided to the file list generator 17 in step S203. The XML file includes data representing the file locations for each clip that was found to satisfy the specified user criteria.
Simultaneous with the searching of step S202, the file list generator automatically provides a voiceover request in step S204. The file list generator parses the command request to separate the criteria data from the voiceover data and send, data corresponding to the voiceover to voiceover server. Voiceover server automatically parses the voiceover metadata to determine the type and style and any other instructions related to the voiceover data prior to converting the text into voice data able to be audibilized in step S206. Upon conversion into voiceover data, voiceover server communicates a location link (i.e. a Universal Resource Locator—URL) corresponding thereto to the file list generator 17 in step S208.
When file list generator 17 receives the media file list generated in step 5203 and the location link generated in step S208, file list generator 17 automatically provides the voiceover location link and media file list to playlist generator 19. Playlist generator automatically and randomly selects one of the music clips contained in the media file list in step S212. Alternatively, should the user specify the desire to have multiple music clips for the media compilation, the playlist generator may automatically and randomly select more than one music clip for use in the media compilation. For the purposes of example, the operation will be discussed having only one music clip for the media compilation. Upon random selection of a music clip from the list of plurality of music clips, playlist generator parses music metadata tag to locate music heartbeat data for the specific music clip. The music heartbeat data includes marks within the music file that subdivide the music file into a plurality of segments. Additionally, each segment may include data representing instructions corresponding to other types of media (i.e. video and graphics that may be used in that particular segment). System 10, in step S214 automatically creates a media playlist by parsing the video and graphic image metadata for each video and graphic image on the media list returned in step S203. Playlist generator 19 automatically compares data for each segment in the music clip with data for each video and graphic image clip and randomly selects and associates respective video and/or graphic image clips that match the criteria specified in the music metadata tag for a particular segment of the music clip. Playlist generator 19 also automatically associates the voiceover data with the media clips. The association of media files with one another is shown in FIG. 3. The list of media clips (video, audio and graphic image) is created in step S216 and playlist generator 19 outputs a playlist as an XML (or other configuration file type) file in step S218. An exemplary XML playlist is shown in FIG. 4 and will be discussed with respect thereto.

It should be appreciated that while file list generator 17 and playlist generator 19 are shown as separate components, that they may be a single component as shown in FIG. 1 or may be further subdivided into additional components as deemed technically necessary.

A schematic view showing the manner in which the media compilation file is produced is shown in FIG. 3. FIG. 3 is an exemplary view of the activities undertaken in steps S210-S214 described in FIG. 2. The list of media clips and voiceover data is indicated by reference numeral 300. Media clip list 300 includes music clips 310, video clips 312, voiceover data 214, graphic image clip 316 and other media clips 318. The music clips shown in media clip list 300 include first music clip 320. The process described below will only be discussed for first music clip 320, however, playlist generator 19 performs the following operations for every music clip shown in media clip list 300. First music clip 320 includes metadata tags 322 including description attributes such as discussed above. Playlist generator 19 automatically parses the music metadata tags to locate a music file that corresponds to as many parameters as are input by a user. As shown herein for exemplary purposes, playlist generator 19 has parsed three levels of metadata to locate all requested criteria. Once playlist generator 19 has parsed all music clips, playlist generator 19 randomly selects one of the music clips satisfying the criteria. For purposes of example, playlist generator has selected first music clip 320. The selected music clip represents the first base media data stream 301 for incorporation into a media compilation file or datastream 305.

Playlist generator 19 further parses first music file 320 for heartbeat data which instructs playlist generator as to how first music file 320 should be subdivided and how to associate other media clips with first music file. Heartbeat data includes a plurality of predetermined marks 324 within and over the duration of first music file 320 defining a plurality of segments thereof. Each defined segment may include instruction data indicating the type of other media file that may be associated with that particular segment. FIG. 3 shows first music file having 8 dividing marks 324 subdividing first music file into eight segments 330-337.

Playlist generator 19 further parses at least one of the video metadata tags for each video clip listed on media list 300, the graphic image metadata tags, and other media metadata tags for attributes or other description information that matches both the user specified criteria from criteria data and which matches music segment instruction data derived from the music heartbeat metadata. Shown herein, playlist generator 19 has parsed and located eight video clips 340-347 or segments of video clips that satisfy both user specified criteria and music heartbeat criteria. Playlist generator 19 randomly selects and automatically associates each respective video clip 340-347 with the corresponding music segment 330-337. The sequential association of video clips with music segments produces a second data stream 302, associated with the first data stream and which is to be included in the media compilation file or data stream.

Upon parsing the graphic image metadata tags, playlist generator locates and randomly selects and associates graphic image clips with at least one segment of the music file according to the music heartbeat data. As shown herein, first graphic image clip 350 is associated with the fourth and fifth segments (333 and 334) of first Music file 320. Additionally second graphic image file 352 is associated with the eighth segment 337 of first music file 320. First and second graphic image files 350 and 352 produce a third data stream 303 for inclusion with the media compilation file and/or data stream 305. Despite third data stream 303 having only two component parts, playlist generator inserts spacing objects within third data stream 303 such that the component parts are displayed at the correct time within the compilation.

Playlist generator 19 further receives the voiceover data and adds the voiceover data as a fourth data stream 304 for inclusion with the media compilation file and/or data stream.

As used in the description of FIG. 3, the term “associate” when referring to video, voiceover and graphic media clips and segments of the selected music clip may include any of providing location identifiers corresponding to the location of the particular media file and data representing the particular media file. Thus, the compilation data stream 305 may include data that represents the locations of each media file on a remote server or in a remote repository or may includes separate data streams of each particular media type.

FIG. 4 is an exemplary media location identifier file 400 formatted in XML that corresponds to an exemplary media compilation produced by system 10 in FIGS. 1-3. File 400 includes a source of the music clip 401 used in the compilation file and music heartbeat data 402 associated with the music clip 401. The music heartbeat data creates the timeline over which other media files will be played. The heartbeat data begins when time equals zero and identifies an end time period which defines the particular segment. For example, segment 1 begins at time=0.00 and ends at time=0.08 and segment 2 begins at time=0.09 and ends at 2.92 and so forth. File 400 further includes a source of the voiceover data 403. As shown herein, the voiceover data will play over the duration of the entire music file 401. However, as discussed above, voiceover data may be divided to play over only specific segments identified within the heartbeat data. File 400 also includes a list of video files 404 that are part of the compilation. For each video clip in list 404, a source 408 of video clip is provided and a sequenceID 405 corresponding to a segment as defined by music heartbeat data. Additionally, for each video clip a start time 406 identifying a time and place within the particular video clip that video clip should begin and an end time 407 indicating the time and place within the particular video clip that the video clip should end.

FIG. 5 is an exemplary user interface 12 for operating the media compilation creation system 10 shown in FIGS. 1-4. User interface 12 includes display area 12 having a plurality of image elements displayed thereon. The media compilation system includes a plurality of media creation features such as the one described above for producing commercials or advertisements that look professionally produced. Additionally, as will be discussed hereinbelow, there are additional media creation features available by using media creation system 10. Feature image element 502 indicates which feature has been selected by a user and further enables a user to change between different features of system 10. For purposes of example, the user interface 12 will be described in a manner enabling a user to produce a commercial for display on the world wide web.

User may select from a plurality of categories 504 identifying a plurality of different business types. Media compilation system enables a user to automatically make a commercial for any type of business or that advertises any time of product depending on the pre-edited media clips that are associated with system 10 at the time of media creation. For example, if a user owns a pizza restaurant and wants to make a commercial advertising the restaurant and wants to emphasize the ambiance of the restaurant, the user selects “pizza” in category 504 and “ambiance” in style category 506. Style category 506 includes any number of different styles such as fun, classy, entertaining, kid-friendly, adults only, etc.

Any style description may be used by system 10. User may also enter specific keywords in keyword section 508 that are important to the user in trying to sell or promote the business. As system 10 enables user specific, randomly generated and not pre-fabricated commercials user interface includes business information inputs 510 allowing the user to enter specific address and contact information for their particular business. Further, user interface includes voice over control element 512 which provides a box allowing a user to enter specific text to be played during the duration of the commercial. Control element 512 further includes voice selector 514 which allows a user to select a male or female voice. The control element shown herein may include any additional voiceover control features such as tonality control, voice speed, adult, children or any other item corresponding to a description of the voice to be used to speak the text entered into the text box. Upon completion of the inputs in user interface, user selects creation button 516 to initiate operation of the system.

In response to the single selection of button 516, user interface communicates the user entered data in data fields with the request processor 15 which creates a command request for communication with system 10. Command request includes criteria data including category, style and other user entered keywords, voiceover data including data instructing the system on producing a voiceover, and data representing business information of the user.

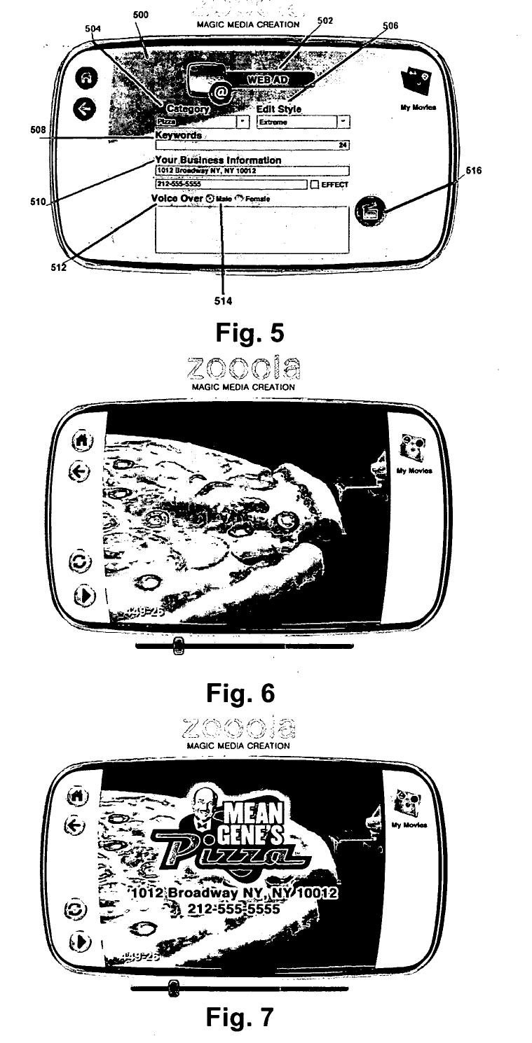

FIGS. 6 and 7 are screen shots of display images presented to the user showing segments of the media compilation that have been selected in response to user input. FIG. 7 further shows the user entered business information being displayed as a graphic image over the video clip that has been selected for that segment. Additionally, the selected music file is being played during the display of the media compilation with in the user interface. Thus, user interface 12 enables both input of user information and also may be used as a player for playing the compiled media.

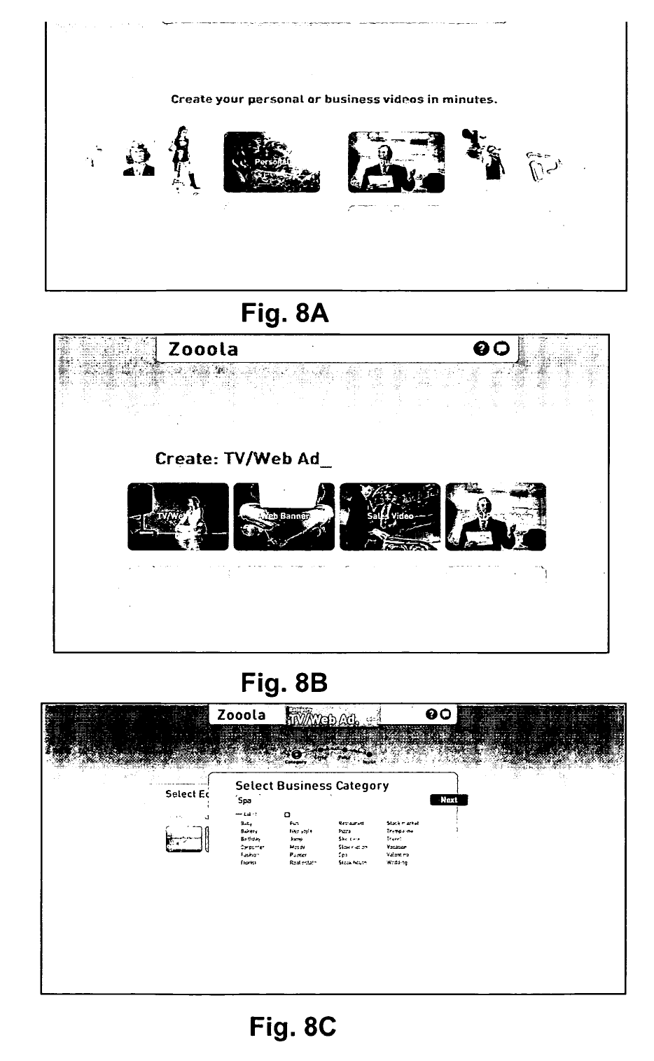

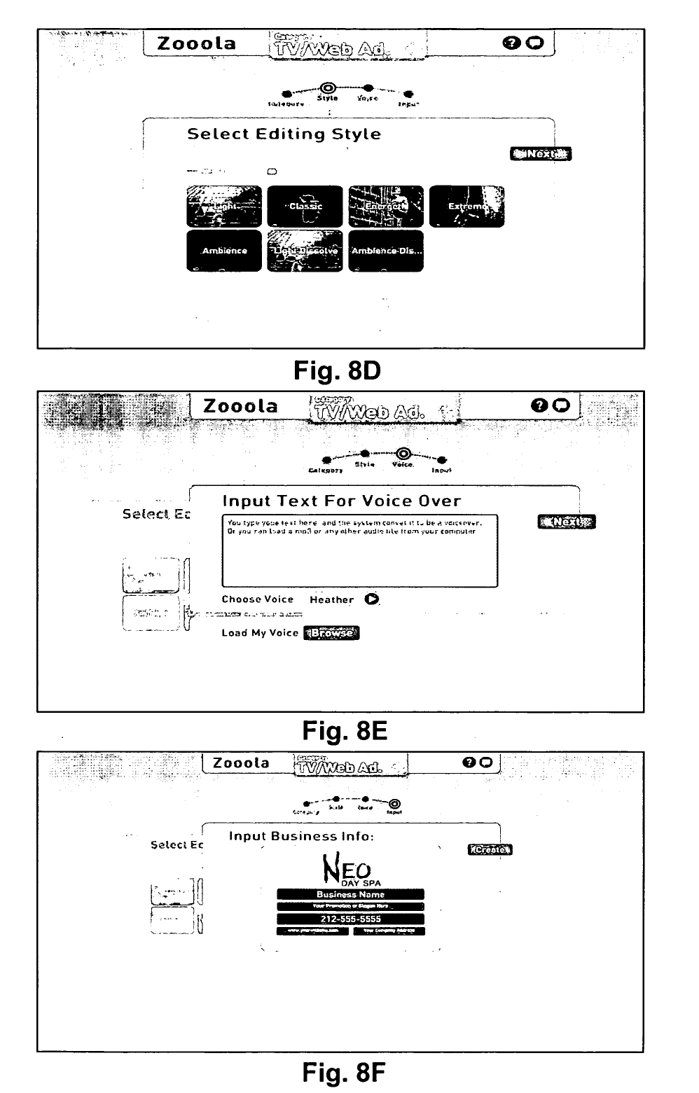

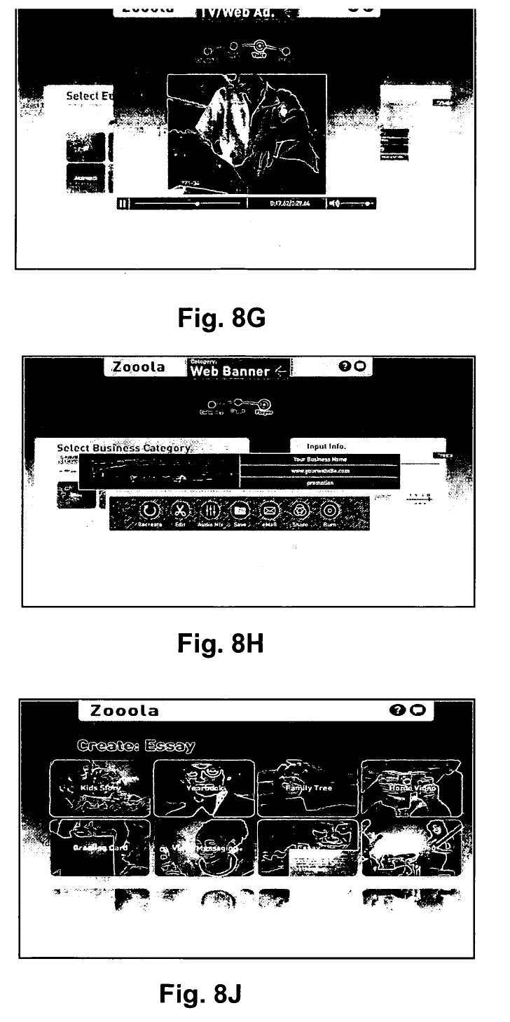

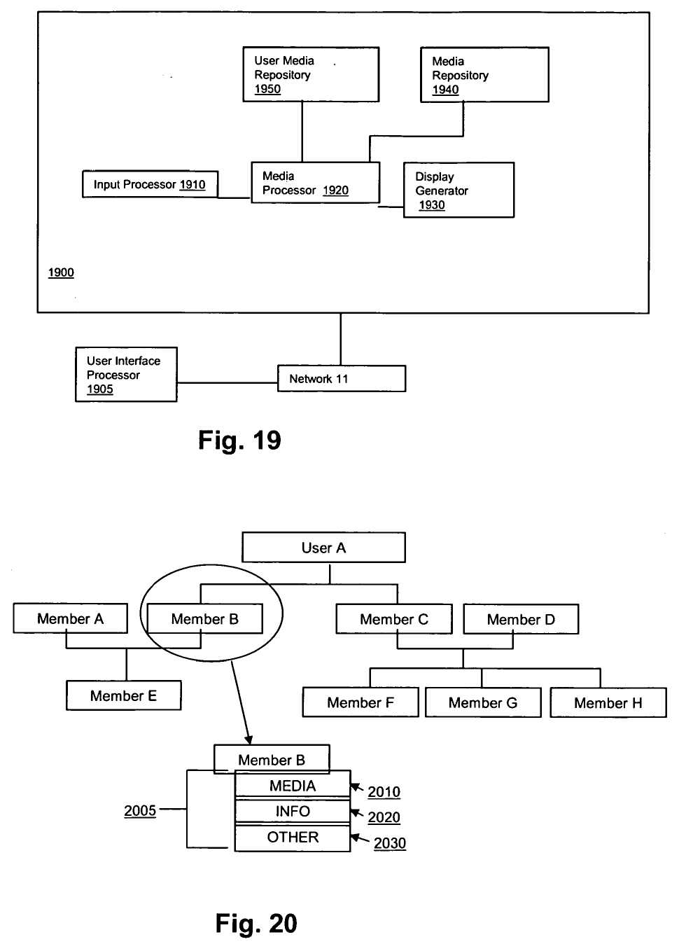

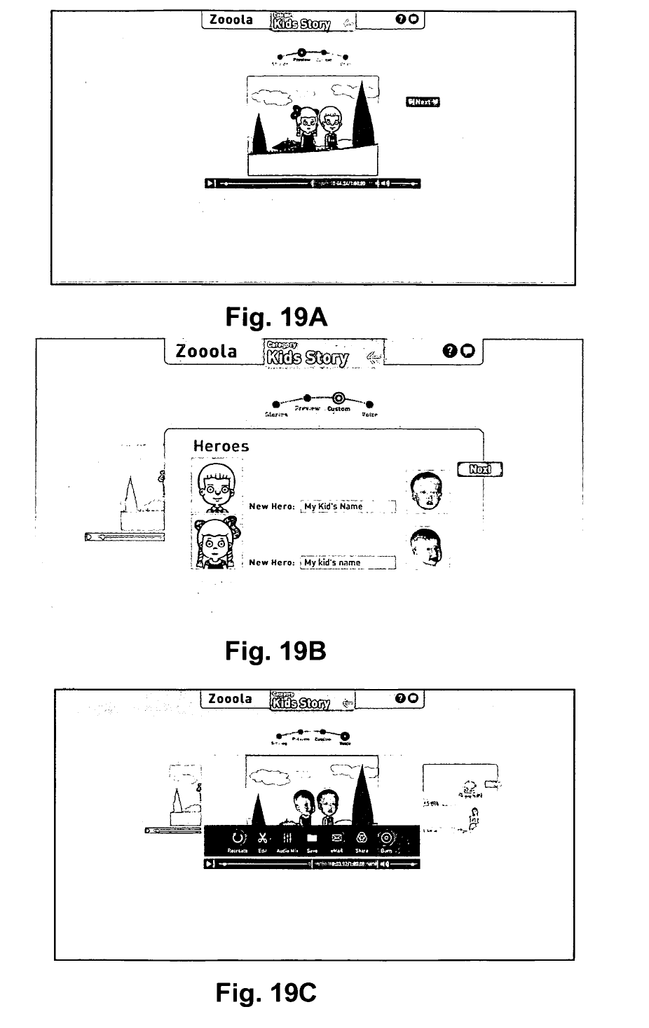

FIGS. 8A-8F are screen shots of a different user interface display images that enable the user to provide criteria data to system 10 for automatically creating a media compilation. The user interfaces shown in FIGS. 8A-8F differ from the user interface in FIG. 5 in that image elements that enable user to create the media compilation are not in a single display image. Rather, the user interfaces shown in FIGS. 8A-8F separate each of the selection and user interaction steps into distinct display images that correspond to a specific task needed to create the media compilation. FIG. 8A is an exemplary start screen that is accessed by the user to begin the media compilation creation. FIG. 8B is an exemplary menu selection display image that allows a user to select the type of media compilation to be created during the current session. As shown here, FIG. 8B is seeking to create a media compilation that may be used as a television or web advertisement video. Once a selection in FIG. 8B is made, a user is presented with the display image shown in FIG. 8C. FIG. 8C is an exemplary user interface display image that allows the user to identify the type of business in which the user is engaged. This selection further provides system 10 with additional criteria data that may be used in searching the various media clip repositories to retrieve applicable media clips that are used to create the media compilation. The user display image in FIG. 8D allows the user to select the type of editing style to be used when producing the media compilation. FIG. 8E provides an exemplary user interface that enables a user to input the text, which, upon media creation will be converted into a voiceover data. Additionally, FIG. 8E provides the user with selection options for selecting a specific voice style to be used when creating voiceover data as well as providing the user an option to selectively upload or supply a data file of the user's own voice. FIG. 8F provides a user display image including fields for receiving user data input corresponding to information about the user or the user's business. Upon entering information in the user interface of FIG. 8F, the user may select a display image element to begin creating the media compilation which is shown in FIG. 8G. Furthermore, the user interfaces shown in FIGS. 8A-8F are easily navigable between one another by using display image elements that allow a user to move between the different display images as needed. Similarly to FIGS. 5-7, the user interface display images shown in FIGS. 8A-8F are shown for purposes of example only and any style user interface that includes image elements for receiving user input and user instructions may be used. FIG. 8H is an exemplary display image of a user interface that is presented when a user chooses the option shown in FIG. 8B for creating a media compilation for use as an advertisement on a web page. Similar invention principles as discussed above and below apply for creating an advertisement using the interface shown in FIG. 8H. FIG. 8J is an exemplary display image of a user interface presented to a person upon selection of a personal media creation option shown in FIG. 8A. The user interface of FIG. 8J includes a plurality of selectable image elements that signal the media processor to operate produce a media compilation from a plurality of different sources. Selectable image elements may initiate media compilation production from any of a word processing document (FIGS. 17-18), a story (FIG. 19) family tree (FIGS. 20-23) and a text message (FIG. 26).

FIG. 9 is an exemplary display image that is presented to the user upon selection of an image element that corresponds to an editing function. The editing function is controlled by media processor 16 (FIG. 1) and is presented to the user upon creation of a first media compilation. Upon creation, the media compilation is viewable in display window 902. Control elements 903 are presented to the user and allow the user to control various display functions associated with the created media compilation playing in display window 902. Control elements 903 may be a single and/or multiple display image elements and may allow a user to any of play or pause the media compilation; scroll along a timeline of the media compilation; view the specific time at which a specific clip or image is displayed and change the volume of the audio data of the media compilation.

Once a user initiates the editing function of the media processor 16, a series of clip windows 904a-904d are displayed to a user. The designation as 904a-904d does not imply that the clips being displayed are the first four clips of the media compilation and is used instead to indicate a general ordered display of individual clips are presented to the user for editing. Scroll image elements 910 and 912 allow a user to scroll along a timeline of the media compilation thereby presenting the different individual clips to the user for editing thereof. Should a user decide that a specific clip (shown herein as 904b) is not desired, the user may move a selection tool (i.e. mouse, light pen, touch screen, touch pad, keyboard, etc) over the non-desirable clip 904b. Upon selection of clip 904b, an image element overlay having two individually selectable user image elements is presented to the user. The overlay includes a load image element 908 and a replace image element 906. Selection of the load image element 908 allows a user to specify a specific media clip at a pre-stored location for use at the particular place in the in the data stream. Alternatively, the user may select the replace image element 906 which re-initiates a search of the various media repositories for a second, different media clip that corresponds to the user criteria data for insertion into the media compilation data stream. Once a replacement clip has been retrieved, the user may select the recreate image element that signals the media processor to re-compile the media compilation using the at least one replacement clip. The editing function enables a user to selective pick and choose different media clips along the entire timeline of the media compilation and re-create the media compilation to user specification. A screen shot of the editing display image described with respect to FIG. 9 is shown in

FIG. 9A.

FIGS. 10A-10C are screen shot user interface display images that enable user editing of the created media compilation. FIG. 10A provides a user display image element with multiple selections available to the user that include media clip editing, audio editing, saving and/or burning of a media compilation and sharing a media compilation via email or other social interaction or networking application (i.e. MySpace, Facebook, etc). FIG. 10B is an exemplary user interface display image including selectable user image elements that enable a user to burn or copy a created media compilation to an optical or magnetic storage media. FIG. 10C is an exemplary user interface display image including selectable user image elements that allow a user to edit various characteristics associated with the audio data used in creating the media compilation. The editing user interface of 10C allows a user to change the individual volumes of any of the music clip, the voiceover data and any the entire media compilation.

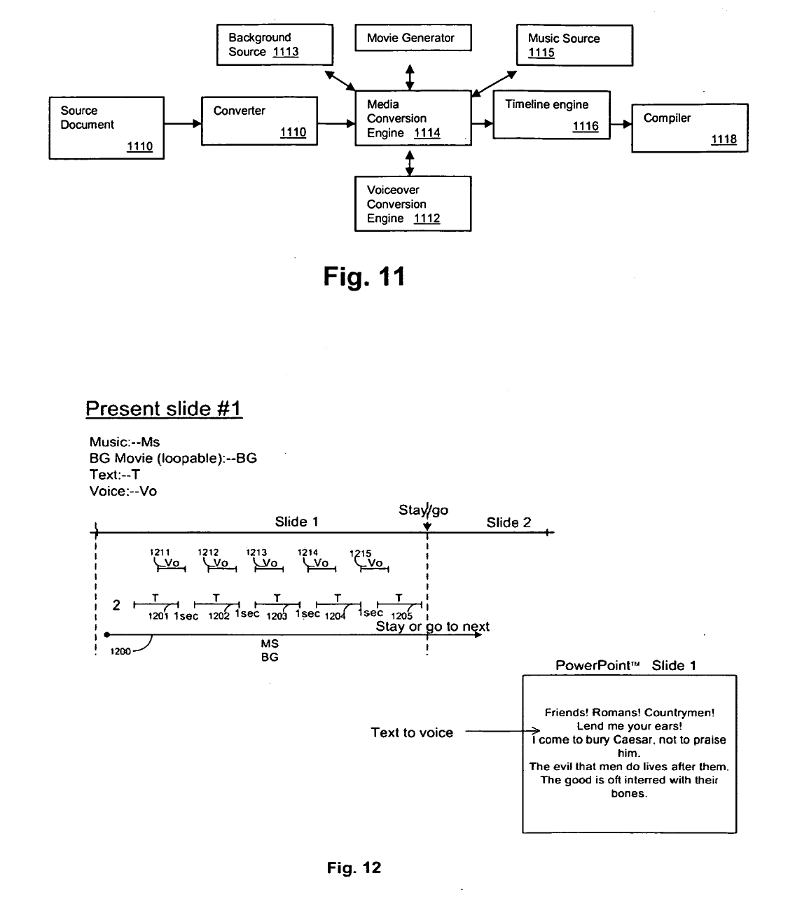

An additional feature of the media compilation system 10 enables a user to transform a slide show presentation that was produced by any presentation application, such as PowerPoint by Microsoft, into a media compilation. FIG. 11 is a block diagram of media compilation system 10 detailing elements used in converting slides from a slideshow presentation into a media compilation. A source slide show document 1100 including at least one slide having data contained therein is provided to a converter 1110. Converter 1110 parses the source data and identifies the components on each slide in the slide show and converts the slide show into an XML document. Converter 1110 may parse the slide show for any of text information, format information, style information, graph information, layout information and comment information. Converter may parse the slide show for any information typically included within a slide show presentation. The converted XML slide show is provided to the media conversion engine 1114 which enables automatic conversion of a text based slide into a multimedia compilation by automatically selecting a loopable background from background repository 1113 and a music clip from music repository 1115. Repositories 1113 and 1115 may be pre-populated with a plurality of background and music styles. Each background and music clip may have metadata tags associated therewith. As discussed above, the metadata tags enable descriptions of use categories for each respective clip. Additionally, metadata tags may include data representing further categorization of the media clip. Loopable background provides the feel of a moving image without distracting a user that is watching the presentation. Media conversion engine 1114 parses the XML file for indicators identifying an object that was contained on the particular slide. Objects include any of bullets identifying text, text fields and graphs. Media conversion engine extracts object data and provides the text describing the object to the voiceover engine 1112 for creation of voiceover data that describes the data object. Media conversion engine 1114 further parses the XML file to determine if any data representing user comments was added for the particular slide. Upon finding data representing comments, media conversion engine 1114 may initiate a search of media repositories using the text identified in comment data as keywords for video, music and graphic images in a manner as described above with respect to FIGS. 1-4 in order to create a audio-video compilation corresponding to a data object on a slide for display to the user.

Media conversion generator 1114 provides a file list including pointers identifying a location of each of background data, music data and voiceover data. The file list is received by a timeline engine which creates a timeline associated with the particular slide based on the duration of the voiceover data. In the event that movie file corresponding to a data object is produced for display, the timeline is created based on length of voiceover data plus the length of any movie file associated with a particular slide. Data representing the timeline is provided along with the list of media files to a compiler 1118 which compiles the sources of data into a media compilation.

FIGS. 12-14 are schematic representations of different type of slides within a slideshow presentation that may be converted by system 10 into a media compilation. FIG. 12 represents a slide having data objects that are text-based as indicated by the lines on the slide labeled PP1 in FIG. 12. Media creation engine 1114 automatically selects data representing a loopable background and music for the particular slide. Background and music data are combined and are indicated by reference numeral 1200. Upon conversion of PP1 into XML, media creation engine 1114 (FIG. 11) parses the XML file for data objects. The data objects located are text based and text is extracted and is shown herein as objects 1201-1205. Each text object 1201-1205 is provided to the voiceover conversion engine 1112 and separately converted into voiceover data 1211-1215. The converted voiceover objects are provided to the timeline engine 1116 which produces a timeline based on the duration of voiceover objects being played for the particular slide. Additionally, in producing the timeline, timeline engine automatically inserts a predetermined pause between voiceover data objects. A user may specify the length of space between voiceover objects by adding spacing data in the comments section of the slide. The result is slide 1 in FIG. 12 is a fully animated media slide that audibilizes the text contained on the slide to further engage the audience that is viewing the presentation.

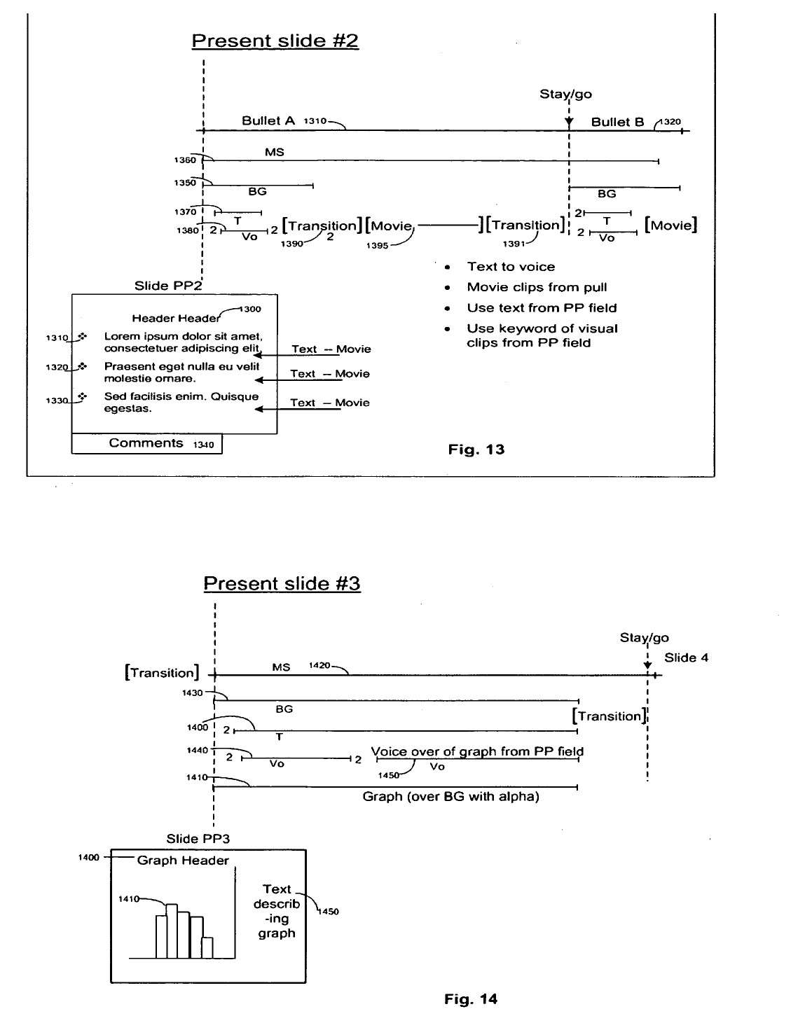

FIG. 13 is a slide having a plurality of data objects including bullet points and text associated with each bullet point. FIG. 13 includes slide labeled PP2 having a header 1300, a first bullet point 1310, a second bullet point 1320 and a third bullet point 1330. Additionally slide PP2 includes a comment section 1340 having comments corresponding to at least one bullet point 1310, 1320, 1330. Each of the three bullet points have text associated therewith. System 10 operates in a similar manner as described above with respect to FIG. 12. Upon conversion into XML, data objects are identified including the text of each bullet point as well as the text associated with each bullet point in the comments section 1340.

FIG. 13 also shows the schematic breakdown of the timeline and display of media elements associated with slide PP2. The schematic shows the timeline based on the data objects identified when media creation engine 1114 parses the XML file corresponding to the slide in the presentation. For purposes of example, the creation of media corresponding to the first bullet 1310 will be discussed. However, the creation of media for other bullets on this or any other slide occurs in a similar manner. Media creation engine 1114 automatically and randomly selects a moving background that is loopable and music. First bullet 1310 includes a text data object 1370 identifying the bullet 1310 which is extracted by media creation engine and provided to voiceover server 1112 for conversion into voiceover data 1380. Slide PP2 may include a data object representing comment data that is associated with the first bullet point 1310. Additionally, slide PP2 may include a movie indicator indicating to media creation engine 1114 that a movie corresponding to the bullet point is desired. In response to the movie indicator, media creation engine 1114 automatically inserts a transitional element 1390 and identifies and provides keywords from the comment data to movie creation engine 16 (FIG. 11). Movie creation engine 16 automatically searches for, retrieves and compiles a list of media clips in a manner described above with respect to FIGS. 1-4. Movie creation engine 16 (FIG. 11) compiles a list of video and or graphic image files that closely correspond to the keywords and randomly selects video and/or graphic image clips for use in a movie that illustrates the information contained in the first bullet point 1310. The movie 1390 created by movie creation engine 16 may include the music selected by media creation engine 1114 or may use the keyword data from the comment section to search a music repository and to select a different music selection and produce a movie in accordance with the process described above with respect to FIG. 3.

Upon creation of the movie 1390, background data 1350, music data 1360, voiceover data 1370 and transitional element 1390 are provided to timeline creation engine 1116. Timeline creation engine creates a timeline based on, for each bullet point, the length of voiceover data plus transition element plus the length of the movie file. Timeline engine 1116 further directs the background data to be displayed with each of the music and voiceover data. Timeline engine 1116 causes background data to cease being displayed in response to the transitional element 1390. Movie 1390 is displayed after transitional element and, upon conclusion of movie 1390, a second transition element is inserted enabling a smooth transition to at least one of data representing the next bullet point or data representing the next slide in the presentation.

FIG. 14 is a slide PP3 having a header 1400 that identifies a graph 1410. The slide is converted into an XML representation thereof. The XML representation of the slide includes a plurality of data objects. Data objects include header 1400 which is text based and graph 1410. As described above, media creation engine 1114 automatically and randomly selects music 1420 and background images 1430 that are looped over the duration of media presentation for the particular slide. Media creation engine 1114 parses the XML file and locates data objects representing the header 1400 and the graph 1410. The data objects are provide to voiceover server 1112 for conversion from text based data to voiceover data. The text of header 1400 is converted to voiceover object 1440 and the XML representation of graph 1410 enables creation of a voiceover that describes each element within graph 1410. Media creation engine 1114 may also selectively parse XML file for data representing a space or pause between different graph elements which may result in the creation of multiple voiceover data objects corresponding to the same graph.

Voiceover objects 1440 and 1450 are provided with music object 1420 and background object 1430 to timeline creation engine 1116. Timeline creation engine 1116 automatically creates a timeline using the combined length of voiceover objects 1440 and 1450. Additionally, timeline creation engine 1116 automatically inserts a pause for a predetermined amount of time between the voiceover objects 1440 and 1450. Furthermore, should more than one voiceover object be associated with the same graph, timeline creation engine automatically inserts the predetermined amount of time between objects as discussed above.

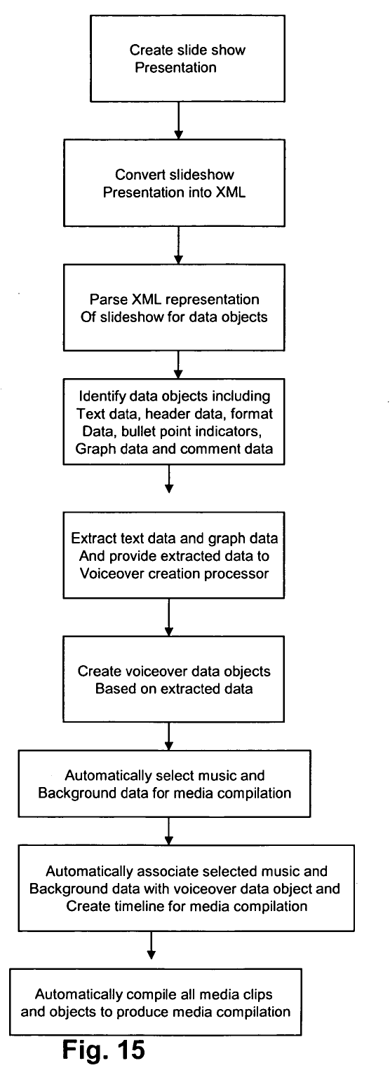

FIG. 15 is a flow diagram detailing the operation of the features of system 10 described in FIGS. 11-14. A user creates a slideshow document in step S1500 using a presentation or slide show creation program wherein the slide show includes at least one slide with at least one data object embedded therein. The slide show document is converted in step S1502 into an XML file. The XML file is parsed in step S1504 for any data objects embedded in the slide show document using XML data object identifiers and identifying, in step S1506, data objects including text data, header data, formatting data, bullet point indicators, graph data and data representing user entered comments in a comment section. The text base and graph data are extracted and provided to voice over creator in step S1508 which creates voiceover data objects based on the extracted text and data as shown in step S1510. Music and background data clips are automatically selected in step S1512 for use in a media compilation. In step S1514, the selected music and background is automatically associated with voice over data objects to create a timeline for the resulting media compilation. Upon creation of a timeline, the media clips and data objects are automatically compiled to produce media compilation.

While each of these slides is described having different data objects, media creation engine 1114 may parse and cause different media files to be created for slides having any number of data object combinations. Additionally, the use of movie created for bullet point data objects is described for purposes of example only and the same principles can be applied to text based slide and/or slides having graphs. More specifically, and for example, should a graph on a slide include a pie chart, comment data may be used to create movie about each particular segment of the pie chart, in addition to the voiceover data associated with that segment. The result of using the features described in FIGS. 11-15 is multimedia presentation of a, previously flat 2D slide that better engages the audience. Additionally, the operation of slide show media compiler is performed automatically and in response to a single user command as the data used to produce the end media compilation is derived from the source slide show presentation document.

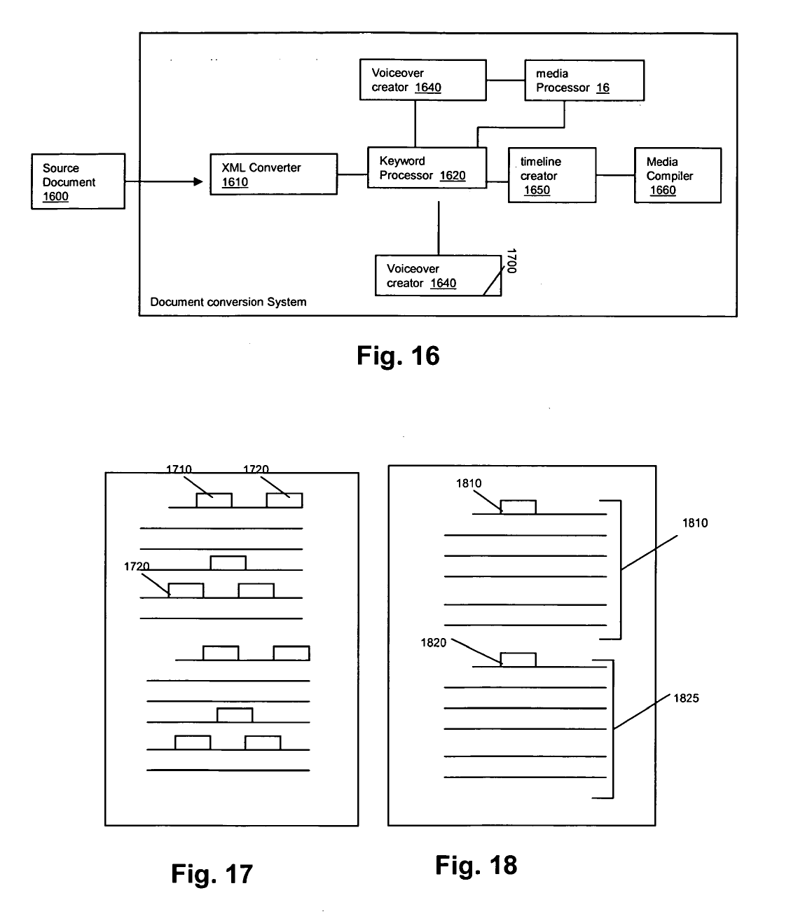

An additional feature of the media compilation system 10 enables a user to provide a source document 1600 that is compatible with a word processing application for conversion into a multimedia movie compilation. FIG. 16 is a block diagram of the word processing document conversion and movie creation system. Source document 1600 includes a plurality of user selected keywords that are identified by the user throughout the source document.

Converter 1610 receives data representing source document 1600 and converts source document from a word processing compatible data format to XML representation of the source document. During conversion, converter 1610 identifies keywords with keyword identifiers indicating that a keyword exists. Additionally, converter 1610 identifies data objects that are text based, for example by sentence and/or by paragraph. Keyword parser 1620 parses the XML file of source document 1600 and logs each respective keyword indicated by a keyword identifier. For each keyword identified by parser 1620, a list is provided to media processor 16, the operation of which is described above in FIGS. 1 and 2. Media processor 16 initiates a search of different media clips in media repository 1630 that are tagged with a term equivalent to the identified keyword to produce an audio-visual file(s) display moving images corresponding to the keyword. The duration of media clips used to produce movie file may depend on the duration of voiceover data object in which the keyword appears or on the duration between the appearance of two different key words in the extracted text based data object. As discussed above, an actual file may be produced or media location identifier file indicating a location of the respective media clips used in the file may be produced and used herein.

Parser 1620 also identifies and extracts text based data objects to be provided to voiceover creator 1640. The voiceover objects created based on the text data objects may be converted into individual sentence data objects or paragraph data objects. Parser 1620 provides the voiceover data objects with the media location identifier file to the timeline creator which creates a timeline based upon the total length of voiceover objects. Additionally, timeline creator utilizes the keyword identifier to mark points in the timeline that indicate when the movie being displayed should be changed to a second different movie file based on the difference in keywords occurring at the particular time. Compiler 1660 compiles the media compilation file an enables the text based document to come to life as an audio visual story telling mechanism. This advantageously enables a user to draft an essay in a word processing application compatible format, for example, on the difference between dogs and cats. If keywords “cat” and “dog” are selected in source document, the media processor advantageously creates two different movie files, one showing video clips about cats and the other showing dogs. The display of the clips is advantageously automatically controlled by the positioning of keywords in the source document and enables a user to view a video on a topic associated with a keyword while having the user's own words audibilized over the video being displayed. While the addition of music to the movie or as background is not directly discussed, it is known that the use of music with this feature may be done similarly as described above with respect to other features.

FIG. 17 is an exemplary source document for use with the system described in FIG. 16. Source document 1700 is a word processing application compatible document having a plurality of text based data. Source document 1700 also includes a plurality of identified keywords. First keyword 1710 is shown juxtaposed in the same sentence with a second different keyword 1720. Throughout source document 1700 first and second keywords appear and may govern the display of certain movie files that were created based thereon. For example, source document 1700 in FIG. 17 may cause a first movie file to play while a portion of the first line of text is being audibilized and switch to a second different movie at the first instance of the second keyword.

FIG. 18 is another exemplary source document for use with the system described in FIG. 16. Source document 1800 includes a first keyword 1810 at a beginning of a first paragraph 1815 in the word processing compatible formatted document and a second different keyword 1820 at a beginning of a second paragraph 1825. System would enable creation of a movie based on first keyword 1810 and display a movie during the audibilization of the text data in the first paragraph 1815. A second different movie created based on second keyword 1820 would be displayed during the audibilization of second paragraph 1825.

Additionally, word processing document conversion and movie creation system may utilize comment data contained in a comment section of the particular word processing compatible formatted document to further control the operation and display of movies based on keywords and creation of voiceover data and/or audibilization of voiceover data. For example, data objects may be parsed and applied to the timeline creator directing a first movie file about a first keyword to play until the second appearance of the second different keyword thereby reducing choppiness of video presentations and/or understandability and watchability of the compilation file.

User interaction with both the slideshow processing system and word processing document conversion and movie creation system may occur via a user interface such as the one depicted in FIGS. 5-10. Display areas on the user interface may provide tools to enable a user to load and select keywords in a document conversion and movie creation system. Alternatively, this functionality may be formed as an applet that is stored on a user's computer and loaded as a plug in into a web browser or into a word processing application.

A video story creation system is shown in FIG. 19. Video story creation system 1900 an input processor 1910 for selectively receiving media clips provided by a user. Media clips may include user-specific graphic images such as personal pictures, for example. Input processor 1910 further receives description data that corresponds to each respective user provided media clip and automatically associates the description data with the media clip as user specific metadata tags. Input processor 1910 communicates user-specific media clips and associated metadata tags via media processor 1920 for storage in a user media repository 1950.

System 1900 includes media repository which is pre-populated with data representing stories that may include at least one character. Story data may include any of text-based data and audio-video story data. Story data has character identifiers marked throughout identifying a character in the story.

Input processor further received a data representing character information from a user via user interface created by user interface creation processor 1905. User interface creation processor 1905 enables creation and display of a user interface that includes image elements allowing a user to provide user-specific media clips and description data to be associated with each respective media clip, data representing a request for a particular story selection and character data for specifying which media clip is to be used to represent a respective character in a particular story. User interface processor 1905 further creates a data request which may be communicated via the communications network 11 to system 1900.

Media processor 1920, upon receiving a data request including story request data and character data, automatically searches user media repository 1950 for user provided images that correspond to the character data specified in data request. Media processor 1920 automatically inserts user provided media clip into story data based on the character data to produce modified story data. Media processor 1920 provides modified story data to display generator which generates a media compilation file includes story data wherein the characters in the story correspond to elements of the user provided media clips.

For example, media repository may include an audio-visual movie depicting the story of Jack and Jill. Throughout the story data, character identifiers are provided identifying each occurrence of “Jack” and each occurrence of “Jill”. User, via user interface, may selectively provide data identifying that the desired story is Jack and Jill and also may upload a picture of a first person and provide data associating the first person as

“Jack” and upload a second picture of a second person and provide data associating the second person as “Jill”. Media processor 1920, upon receiving these data requests, automatically retrieves the story data and automatically inserts the first picture each time “Jack” is displayed and the second picture each time “Jill” is displayed. Thus, once modified, the story may be output by display generator 1920 and provide an audio-visual media compilation of a known story but the characters are replaced based on user instruction. This is described for example only and any story may be used. Additionally, while story data here is pre-made audio-video data, system 1900 may automatically and randomly create a story using keywords and user selections in a manner discussed above with respect to FIGS. 1-10. Additionally, user may employ system shown in FIGS. 16-18 to automatically convert a text story to a movie wherein the keywords included in the text may also serve as character identifiers signifying insertion of a particular user provided media file.

FIGS. 19A-19C are screen shots of exemplary display image user interfaces that are presented to a user when using system 1900. FIG. 19A provides a display image media player that plays an animated media clip that corresponds to the story chosen by the user. FIG. 19B is a user interface display image that enables the user to selectively modify any of the characters of the story. In the example shown and discussed above, the story selected is “Jack and Jill”. FIG. 19B provides the user various selectable image element to change any aspect of the character that will be presented to the user as the story compilation. A user may use the image elements to change any of the characters name, picture, sex and age. The character modification described herein is for purpose of example only and any descriptive feature of the character may be modified using a similar interface. FIG. 19C is an exemplary display image showing the compiled story using the characters as modified by a user. FIG. 19C shows the compilation including actual digital photograph of the users' children thus providing a more personalized story.

FIGS. 20-22 illustrate an automatic family tree media creation system 2000 that enables a user to create data representing their family tree and provide user-specific media clips including audio, video, and graphic image media clips for each member of the family tree. The user provided media clips will be tagged by a user to include descriptors identifying characteristics of the particular family member and data representing media clip associations enabling multiple family members to be associated with a single media clip. Additionally, user interface includes image elements enabling a user to select descriptors from a predetermined list of descriptor categories that may be used to describe the media being provided. For example, predetermined descriptors may include, but are not limited to, birthday, wedding, travel, vacation, etc. Additionally, the image elements representing predetermined descriptors may also be used by the user as keyword selections whereby system 2000 may automatically create a media compilation file based on different media clips that have the same keywords as those entered by the user in the user interface. FIG. 20 is an illustrative version of data representing a family tree for user A. Each box shown in FIG. 20 represents a particular member of the family tree. Family tree includes Members A-H at different generational levels. Each member of the tree includes a data record having a family tree metadata tag associated therewith. Shown herein is an expanded view of the record of Member B. Member B has metadata record 2005 associated therewith. Record 2005 includes a first data field 2010, a second data field 2020 and a third data field 2030. First data field 2010 may include identifiers identifying particular media clips to be associated with Member B. Second data field 2020 may include descriptors that describe at least one of Member B and media clips associated with Member B. Descriptors in field 2020 may include data represent any of members age, profession, interests, special relationships or any other data that may provide a description of the Member. Third data field 2030 may include any other identification data that may be used by system 2000 to create a media compilation file including media associated with at least that particular Member.

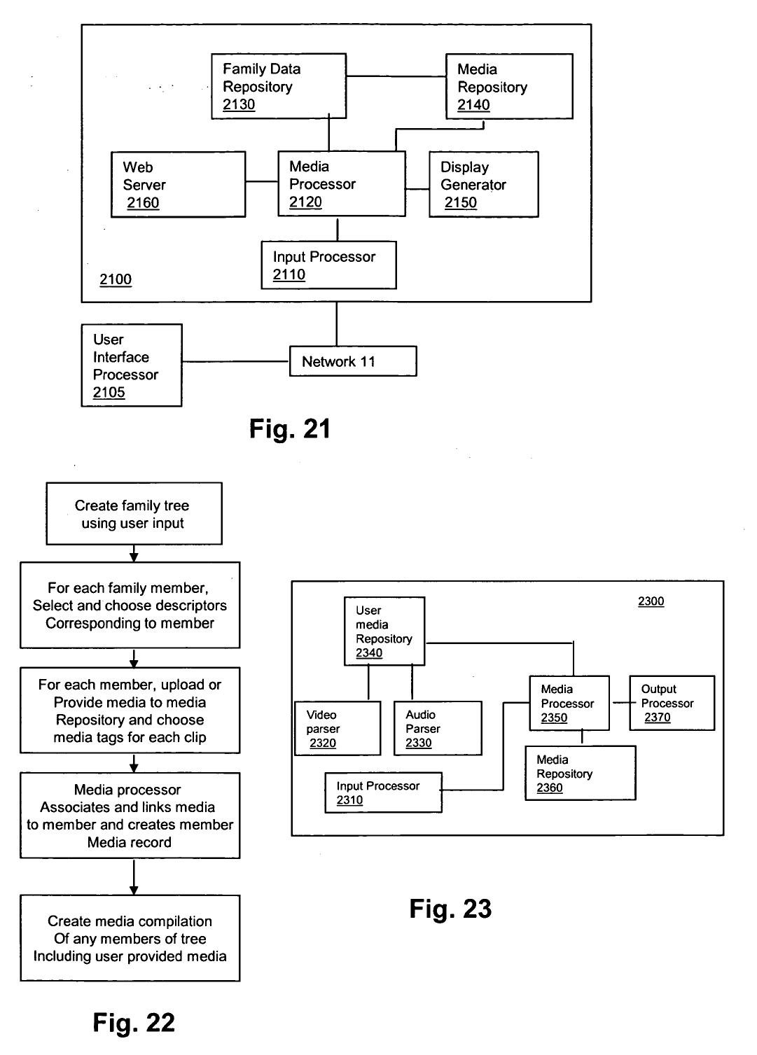

Family tree media creation system 2000 is shown in a block diagram in FIG. 21. A user may interact and connect with system 2000 via communications network 11 by using a user interface that is generated and displayed to a user by user interface processor 2105. User interface generated by user interface processor 2105 includes a plurality image element and user input data fields that allow a user to input data representing a family tree such as shown in FIG. 20. Additionally, user interface includes image elements and input data fields that allow for selection, associations and description of a plurality of media clips for any member of the family tree. Additionally, user interface may include image elements enabling at least one of selection of particular descriptors and input of particular descriptors that may be associated with at least one member of the family tree. Upon selection or entering of descriptors, user interface provides an image element responsive to a single user command that initiates automatic generation of a media compilation file including media clips corresponding to the descriptors selected or entered by the user.

System 2000 includes input processor 2110 for selectively receiving data entered by a user via user interface. Input processor 2110 sorts the received data to separate data defining a family tree, data describing members of a family tree and media clip data. Input processor 2110 executes an executable application that utilizes family tree data to produce a family tree of the particular member. Input processor 2110 parses media clip data and family tree description data to automatically create family tree metadata tag for each member of the tree. Input processor 2110 provides and stores family tree data and family tree description data in family data repository and causes media clips to be stored in media repository 2140.

Media processor 2120, in response to a single user command, automatically searches family data repository 2130 and media repository 2140 for media clips that correspond to descriptors selected by a user at the user interface. Media processor 2120 automatically retrieves the media clips and provides the clips to display processor 2150 which automatically, in random order, compiles the media clips into a media compilation file in a manner described above. Display processor 2150 communicates data representing the media compilation file to the user for display in a display area of user interface. User may selectively save the media compilation file on a local computer system and/or may receive a link (URL) that will point a user to the file on a remote system.

System 2000 further includes a web server 2160 that enable hosting of a web page that corresponds to a users family tree data which may be shared among other users of system 2000. Additionally, web server 2160 may include a media player applet that enables playing of the media compilation file. Web server may include a community functionality to enable all members of the family tree to be able to view, edit and create media compilations from all of the media and description data associated with the particular family tree. Additionally, community functions enable users to communicate in real-time or on message boards with one another.

FIG. 22 is a flow diagram detailing the operation of the system shown in FIGS. 20 and 21. In step S2200, a user creates a family tree based on user input. For each member of the family tree, a user selects and chooses description data corresponding to the member as shown in step S2210. In step S2230, media clips may be uploaded and/or provided for each member of the family tree and includes selected media tags associating the media with members of the tree. Media processor automatically associates and links the media to the member and creates member media record in step S2240 and in step S2250, a media compilation based on user input and request is created and includes user specific media clips for members of tree.

FIG. 23 is a block diagram of a user entered media clip editing system 2300 for automatically tagging and identifying segments of user provided media clips for use as part of a media compilation file. Input processor 2310 is able to receive a plurality of different type of media clips from a user. Receipt by input processor 2310 may be by upload or by reading from a storage media such as a CD or DVD or hard disk drive. Input processor 2310 further is able to receive user input data representing a description of the particular media clip and automatically associate description data with the particular corresponding media clip. Additionally, input processor 2310 may receive data entered via a user interface having image elements enabling a user to select descriptors from a predetermined list of descriptor categories that may be used to describe the media being provided. For example, predetermined descriptors may include, but are not limited to, birthday, wedding, Bar Mitzvah, travel, vacation, etc. Additionally, the image elements representing predetermined descriptors may also be used by the user as keyword selections whereby system 2000 may automatically create a media compilation file based on different media clips that have the same keywords as those entered by the user in the user interface

Input processor 2310 further detects the file format of the media clip received and determines if the media clip is a video data clip or an audio data clip. All video data clips are provided to video parser 2320 for processing thereof to provide data identifying useable segments of the video clip for use in a media compilation. Video parser 2320 selectively segments the video clip according to predetermined video editing techniques and inserts identifiers corresponding to the segments that are deemed usable. For example, video parser 2320 may access a repository of data representing known video editing techniques such as zoom in, zoom out, pan and any other camera motion. Video parser 2330 may also access data representing non-usable segments, for example data corresponding to quick camera movement in a particular direction, quick zoom in, quick zoom out, etc. Video parser 2320 may automatically append segment description data in video metadata associated with the particular video clip to identify the particular segment as usable or non-usable within a media compilation. Thus, the result is a user provided video clip that includes editing tag marks and which may be used by a media processor in any of the systems described above. The resulting user provided video clip may be stored in a user media repository 2340. All audio data clips are provided to audio parser 2330 for automatic analysis. Audio parser 2330 automatically analyzes the audio data to create audio heartbeat data for the particular audio clip. Audio parser 2330 automatically appends data representing the audio heartbeat to audio metadata associated with the particular clip. Thus, the result is a user provided audio clip that includes heartbeat data indicators which may be used by a media processor in any of the systems described above.

Media processor 2350 functions similarly to the media processors described above and, in response to a single user command, automatically searches for and retrieves both user provided clips from user media repository 2340 and other pre-fabricated media clips from additional media repositories 2360. Media processor 2350 may automatically select a plurality of media clips for use in producing a media compilation file in the manner described above with respect to FIGS. 1-10. The media compilation file is provided to an output processor 2370 for transmission for receipt by a user. Transmission may be performed by any combination transmission of a file or an identification file over a communication network and creation of hard copy media such as for example writing data onto a CD or DVD for distribution via other methods.

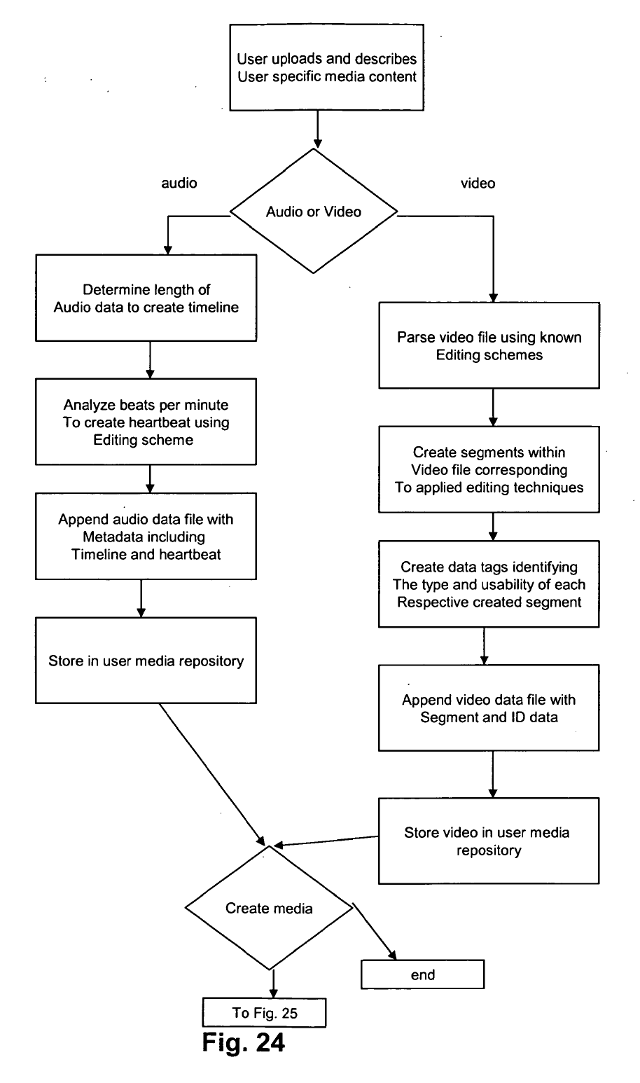

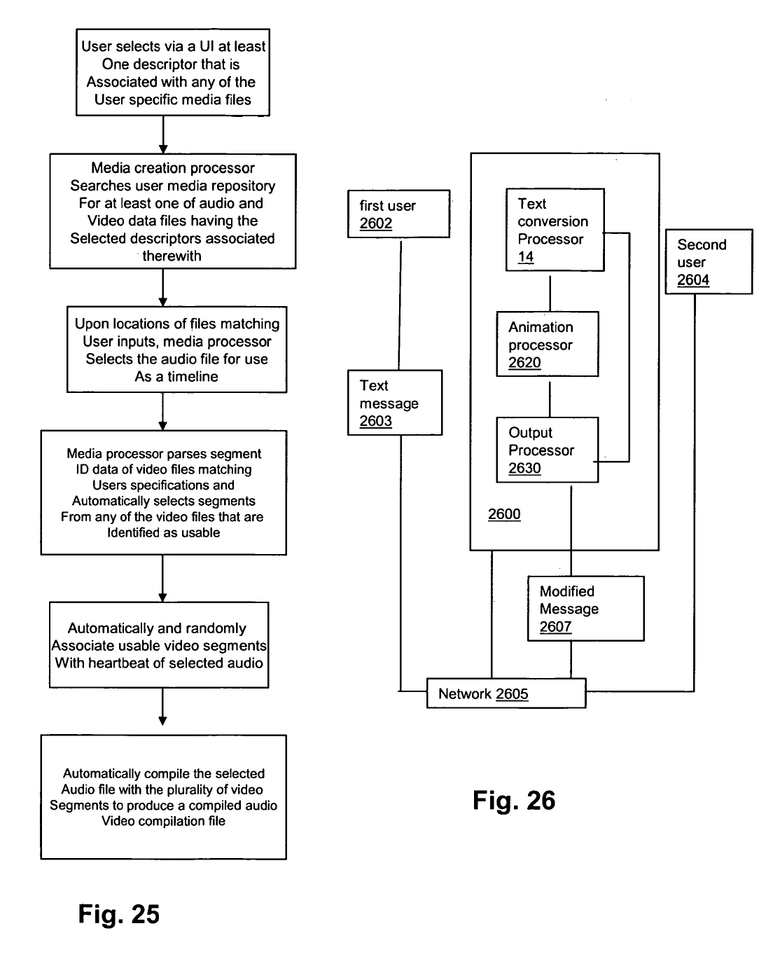

FIGS. 24 and 25 are flow diagram detailing the operation of the system described above. In step S2400 a user uploads and describes using predetermined descriptors media content provided by a user and which is received by an input processor of system 2400. Input processor determines if the media clip provided by the user is an audio clip or a video clip in step S2410. If input processor determines the clip is an audio clip then, in step S2411, audio parser determines a length of audio data to create timeline for the audio data. Additionally, in step S2413, audio parser may analyze beats per minute of audio clip to create heartbeat data using a predetermined editing scheme data, for example, by inserting heartbeat indicators every 10th beat per minute or every 16 seconds such that the heartbeat indicators define the heartbeat data for the particular file. In step S2415, the audio data file is appended with media metadata including timeline heartbeat data. The audio data file is then stored in a user media repository (or any repository) for later use in step S2417.

If the determinations in step S2410 results in the media clip being a video data clip, the video data file is parsed using data representing known editing techniques as in step S2412. In step S2414, segments are created within the video file corresponding to applied known editing techniques and data tags identifying the type and usability of each respective created segment are created in step S2416. The video data file is appended with segment data and ID tag data in step S2418 and stored in user media repository in step S2420. System 2400 further determines in step S2422 if a user desires to make a media compilation file. If not, then operation ends at step S2423. If the user does desire to make a media compilation file, then the method continues in FIG. 25.

FIG. 25 is a flow diagram detailing the media compilation creation process using media clips that have been provided and edited by a user. In step S2500, a user selects, via a user interface, at least one descriptor that is associated with any of the user specific media files. Media processor automatically searches user media repository for at least one of audio and video files having the selected descriptor associated therewith in step S2510. In step S2520, upon location of at least one audio and video file matching user specification media processor automatically and randomly selects the audio file for use as a timeline. The media processor parses segmentID tag data of a plurality of video files matching users specification and automatically and randomly selects segments from any of the video files that are identified as useable in step S2530. Step S2540 shows system automatically and randomly associating usable video segments with heartbeat of the selected audio. The selected audio clip is automatically compiled with the plurality of segments of video clips to produce a compiled audio video compilation viewable by a user over a communication network.

FIG. 26 is a block diagram of a system 2600 that automatically converts text data received in a mobile message format into at least one of audio data message and video data message to be displayed on at least one of a personal computer or mobile computing device (i.e. cellular phone, personal digital assistant, etc). System 2600 enables a first user 2602 of a mobile communications device able to transmit text based messages to a second user of a computing device 2604 via a communications network 2605 such as a cellular phone network and/or a IP based network or any combination thereof.

First user creates a text based message data 2603 and sends the text based 2603 message over communications network 2605. System 2600 receives message 2603 automatically converts text message into a video message 2607 which is output and communicated to the second user 2604. First user 2603 may selectively determine if the text based message is to be converted into audio or video data. First user may select an image element on mobile communications device prior to initiating a send command and sending the text based message.

Text conversion processor 2610 of system 2600 automatically parses the text message for conversion identifier identifying the destination format for the file. If conversion identifier indicates that the message data is to be converted from text to audio, text conversion processor 2610 automatically converts the text into an audio clip file and provides the audio clip file to output processor which uses destination routing information associated with the text message in a known manner to route the modified message 2607 to the second user. Modified message 2607 may be any of an audio message clip and a video message clip.

If conversion identifier indicates that the message data is to be converted from text to video, text conversion processor operates as described above to convert the text into audio data. The audio data is provided to the animation processor which automatically and randomly selects a graphic image and animates the graphic image using the audio data. The animated image and audio data are provided to the output processor which produces modified message 2607 and routes message 2607 to the correct destination.

Graphic image may be a person's face and the image pre-segmented to identify different facial regions for the particular image. For example, regions may include, mouth, first eye, second eye, nose, forehead, eyebrow, chin, first ear, second ear, etc. Any region of the face may be identified and used as an individual segment. Each segmented region further includes vector data representing a predetermined number and direction of movement for the particular region. Each segment further includes data representing a range of frequency identifiers indicating that the particular movement for that particular region may be used. Animation processor 2620 further automatically analyzes the converted audio data to produce a frequency spectrum having a duration equal to the duration of the audio file. Animation processor 2620 automatically analyzes the peaks and troughs of the frequency spectrum over particular time periods within the spectrum to produce a frequency identifier for that particular segment. Animation processor 2620 compares the frequency identifiers with the frequency identifiers for each moveable region and automatically and randomly selects matching movement vectors for each region over the duration of the audio data message. Output processor 2630 encapsulates movement data for each region in the graphic image and synchronizes the audio data with the movement data to produce the animated video message. It should be appreciated that system 2600 may selectively receive user specific graphic images which may be segmented at least one of automatically by a image segmenting application or in response to user command. Thus, system 2600 enables a user to modify their own graphic image to convey a text based message as an animated video message.

The system discussed hereinabove with respect to FIGS. 1-26 may be formed as a single conglomerate system having components and capability specified above. Alternatively, any combination of components and/features described is contemplated. The system described hereinabove provides an automatic media compilation system that automatically and randomly, using a creative intelligence algorithm, creates media compilations that may be viewed by a user. The functions performed by the various processors may be hard coded to various hardware devices and/or may be provided as a single or multiple executable applications that are interrelated and interact with one another operate as described above or any combination thereof. Additionally, the system may be stored on a computer readable medium such as, for example, on a hard disk drive either locally to a computer or remotely accessible by a computer or on digital storage medium such as a DVD or CD which may be inserted and read by a computing device or as a plurality of individual applications that are selectively downloadable either on demand or as a whole. The features and applications of the system as described above may be implemented by any computing device including a personal computer, cellular phones, personal digital assistants, servers and any combination thereof.

Although the preferred embodiments for the invention have been described and illustrated, the specific charts and user interfaces are exemplary only. Those having ordinary skill in the field of data processing will appreciate that many specific modifications may be made to the system described herein without departing from the scope of the claimed invention.

What is claimed is:

1. A media creation system comprising:
a repository having a plurality of different types of media files stored therein, said media files each having metadata associated therewith;
an input processor for receiving user specified criteria data,
a media processor for,
automatically initiating a search of media files stored in said repository based on said received criteria user to produce a list of a plurality of different types of media files wherein each respective media files satisfies said criteria, and
automatically and randomly selecting a first media file in a first data format from said list and at least one other media file in a second data format, said at least one second media file being associated with said first media file; and
a compiler for producing a media compilation file for display . including said first and said at least one second media file, said at least one second media file being displayed concurrently with said first media file.

2. The media creation system as recited in claim 1, wherein
said metadata of said first media file includes data defining a plurality of segments within said first media file, said plurality of segments being useable as a timeline for said media compilation file.

3. The media creation system as recited in claim 2, wherein
said metadata, for each respective segment, further includes data representative of a characteristic of said respective segment for use in associating said at least one second media file with a particular segment of said first media file.

4. The media creation system as recited in claim 2, wherein
said media processor automatically and randomly assigns one of a plurality of second media files to a segment of said first media file.

5. The media creation system as recited in claim 1, wherein
said media plurality of media files stored in said media repository include at least one of (a) audio format media files, (b) video format media files, (c) graphic image format media files and (d) a file having any combination of (a)-(c).

6. The media creation system as recited in claim 1, wherein
said first media file is an audio format media file, and
said second media file format is at least one of a (a) video format media files, (b) graphic image format media files and (c) a combination thereof

7. The media creation system as recited in claim 1, wherein
said criteria data further includes data representing user entered text data for producing said compilation media file, and further comprising
a text-to-voice to voice conversion processor for converting said user entered text data to audio data able to be audibilized.

8. The media creation system as recited in claim 7, wherein
said compiler automatically associates said audibilized text data with said first media file and said at least one second media file for output concurrently therewith.

9. The media creation system as recited in claim 1, further comprising
a user interface including a plurality of user selectable image elements enabling selection and input of at least one of said criteria data and data representing user entered text.

10. The media creation system as recited in claim 1, wherein
said system is responsive to a single user command and said media compilation file is automatically and randomly produced in response to said single user command.

11. The media compilation system as recited in claim 1, wherein
said media compilation file is at least one of (a) a composite media file including each media clip available as a single file for download and (b) an extensible markup language file including location information identifying the location of each respective media clip comprising said compilation and data representing an order in which the media files are to be displayed.
